(19) United States
(12) Patent Application Publication
(10) Pub. No.: US 2011/0320291 A1
(43) Pub. Date: Dec. 29, 2011

(54) SYSTEMS AND METHODS FOR ASYNCHRONOUS MOBILE AUTHORIZATION OF CREDIT CARD PURCHASES

(76) Inventor: Jonathan C. Coon, Austin, TX (US)

(21) Appl. No.: 13/102,925

(22) Filed: May 6, 2011

Related U.S. Application Data
(63) Continuation-in-part of application No. 12/824,974, filed on Jun. 28, 2010.

(51) Int. Cl. G06Q 20/00

(52) U.S. Cl. 705/16

(57) ABSTRACT

An exemplary system includes an asynchronous transaction authorization (“ATA”) subsystem configured to record prior approval of transaction parameters from the account holder(s) and approve a transaction with congruent parameters within a subsequent defined time period. If the parameters of a transaction attempt have not been previously authorized by the account holder(s), the parameters of the requested transaction are stored and the transaction is rejected. The ATA subsystem then queries all associated account or card holders (“ACHs”) providing the parameters of the attempted transaction. Upon authorization from the required ACHs, which is a predefined subset of all the associated ACHs, the purchaser and all ACHs may be notified of approval. The subsequent attempted transaction with congruent parameters will be authorized. Communications between a purchaser and a point of sale device may utilize near field communication (“NFC”) technology. Other security measures such as unique PIN and telephone numbers may be used.

### RELATED APPLICATION

The application in a Continuation-in-Part application of U.S. patent application Ser. No. 12/824,974, filed on Jun. 28, 2010, and entitled SYSTEMS AND METHODS FOR ASYNCHRONOUS MOBILE AUTHORIZATION OF CREDIT CARD PURCHASES, which patent application is incorporated herein in its entirety by this reference.

### BACKGROUND

In 2009, forty-three percent of reported theft crimes were lost or stolen wallets, checkbooks, credit cards, and debit cards. Additionally, credit and debit card fraud is reported as the #1 fear of Americans. As a result, solutions to prevent credit and debit card fraud are critical to economic stability and consumer confidence.

Credit and debit card fraud is rampant, at least in part, due to the ease with which a criminal can access funds without the owner's authorization. A credit card can be charged without the cardholder's authorization simply by entering the card number and expiration date into a card processing terminal or processing application. With limited security features, it is extremely easy to obtain a cardholder's number and expiration date (from any charge receipt in a restaurant for instance) and to charge that card without the owner's authorization.

Even more unfortunate, when a cardholder's account is used without the cardholder's authorization, the burden rests with the cardholder to dispute the charge and fill out paperwork to ensure that the cardholder does not have to pay for the unwanted or fraudulent activity. Often, the notice that a fraudulent charge has taken place will not be discovered until days or weeks after the activity has occurred.

The latency in receiving a notice of fraudulent charge activity is amazing when considering the technology that is readily available to most people by way of cell phones, handheld computing devices, laptops, and the like. For example, in 2007, nearly eighty-five percent of Americans owned a cellular phone, and the percentage has continued to rise. Most cell phones are sophisticated embedded devices, capable of sending and receiving data. Development of new applications for the higher end cell phone models has led to great innovation. However, many users use phones that are not powerful enough to run such applications. Consequently, credit card fraud solutions using other mobile computing features have not proven to be effective, nor have they been widely adopted.

### SUMMARY

A system for asynchronous mobile authorization of credit card purchases includes, according to one exemplary embodiment, an asynchronous transaction authorization (“ATA”) subsystem configured to selectively approve or reject credit card transactions based on a number of parameters. According to one exemplary embodiment, pre-authorization for a credit card transaction may be obtained by submitting the anticipated transaction cost to the ATA prior to purchasing the items. According to this exemplary embodiment, the account holder may pre-authorize a specific transaction amount such that if a transaction is executed for the pre-authorized price, within a pre-defined amount of time, the transaction will be approved. Furthermore an account holder may supply the ATA with a range of anticipated prices rather than an exact transaction amount, in order to obtain pre-approval. Yet further, pre-authorization may be requested by an authorized card holder to allow or activate the card for an anticipated transaction. Pre-authorization would permit the execution of a transaction during a first attempt for a transaction that exceeds a pre-determined threshold that would typically require authorization. Furthermore, a card issuing bank may incorporate the present exemplary systems and methods and provide additional information, including verification that a desired transaction would be approved, thus further eliminating potential issues and embarrassment caused by an overdrawn account.

In another exemplary embodiment, the asynchronous transaction authorization (“ATA”) subsystem is configured to reject an initial transaction request from a merchant if it exceeds a predetermined threshold amount that has not been preapproved. The parameters of the requested transaction are stored by the ATA subsystem which then queries all associated account or card holders providing the parameters of the attempted transaction and requests authorization. Upon authorization from a sufficient number of required associated account or card holders, which is a predefined subset of all the associated card holders, the purchaser and all associated account or card holders may be notified of approval. The subsequent attempted transaction with congruent parameters will be authorized. Authorization will no longer be active after the subsequent transaction has been approved or a time, delta, has lapsed.

In yet another exemplary embodiment, the threshold amount provided in the system may be a cumulative amount determined by a period of time rather than a single transaction.

Another exemplary embodiment relates to a credit theft prevention system that includes a processor, memory in electronic communication with the processor, and an asynchronous transaction authorization (“ATA”) module disposed on the memory. The ATA module, when accessed by the processor, is configured to receive a transaction request at a point of sale device initiated with a purchaser's cellular phone having a near field communication (“NFC”) device, and communicate a purchase amount from the point of sale device to the cellular phone using the NFC device. The ATA module, when accessed by the processor, is also configured to receive pre-authorization requests for the purchase amount from the purchaser via the cellular phone including the NFC device, transmit a credit card number for the transaction from the cellular phone to the point of sale device using the NFC device, and process the transaction.

The ATA module, when accessed by the processor, may further be configured to request separate authorization for the transaction from at least one authorized cardholder associated with the credit card via at least one of SMS, MMS and SMTP. Processing the transaction may include at least some of the steps of recording data related to the transaction, declining the transaction at the point of sale device, requesting authorization for the transaction from at least one authorized cardholder associated with the credit card, storing data associated with the authorization when the requested authorization is received, prompting the purchaser to re-try the transaction, receiving data associated with the re-try transaction, comparing the data associated with the re-try transaction to data associated with the authorization, and approving the transaction when the data associated with the re-try transaction is sufficiently similar to the data associated with the authorization.

Another example credit theft prevention system includes a processor, memory in electronic communication with the processor, and an asynchronous transaction authorization (“ATA”) module disposed on the memory. The ATA module, when accessed by the processor, is configured to receive a transaction request at a point of sale device having a first near field communication (“NFC”) device initiated with a purchaser's cellular phone having a second NFC device, communicate a purchase amount from the point of sale device to the cellular phone, receive authorization for the transaction at the purchase amount from the authorizing account holder and ATA to the point of sale device via the Internet, obtain a credit card number associated with the second NFC device via the first NFC device, and process the transaction.

A further exemplary embodiment relates to a credit theft prevention system that includes a processor, memory in electronic communication with the processor, and an asynchronous transaction authorization (“ATA”) module disposed on the memory. The ATA module, when accessed by the processor, is configured to receive a transaction request at a point of sale device initiated with either a purchaser's cellular phone having a near field communication (“NFC”) device or the point of sale device, communicate a purchase amount from the point of sale device to the cellular phone using the NFC device, receive authorization for the transaction at the purchase amount from an authorizing account holder and the ATA via the cellular phone using the NFC device, obtain a credit card number associated with the NFC device from the NFC device after receiving authorization for the transaction, and process the transaction.

Another example credit theft prevention system includes a processor, memory in electronic communication with the processor, and an asynchronous transaction authorization (“ATA”) module disposed on the memory. The ATA module, when accessed by the processor, is configured to receive a transaction request initiated with a purchaser's cellular phone, the transaction request including a purchase amount and being sent to a telephone number unique to the purchaser, determine whether the purchase amount exceeds a threshold purchase amount, if the purchase amount exceeds the threshold amount, obtain authorization for the transaction from at least one account holder, and provide authorization for the transaction to the purchaser.

The ATA module may further be configured to obtain pre-authorization of an imminent transaction by transmitting a pre-authorization request to a card issuing bank, receiving pre-approval of the imminent transaction from the card issuing bank, and notifying the purchaser and an account holder of the pre-authorization by the card issuing bank.

### BRIEF DESCRIPTION OF THE DRAWINGS

The accompanying drawings illustrate various embodiments of the principles described herein and are a part of the specification. Together with the following description, the drawings demonstrate and explain the principles of the exemplary system and method. The illustrated embodiments are merely examples and do not limit the scope of the disclosure.

FIG. 1 is a block diagram illustrating an exemplary asynchronous mobile authorization system, according to principles described herein.

FIG. 2 is a block diagram illustrating an exemplary asynchronous mobile authorization system, according to principles described herein.

FIG. 3 is a block diagram illustrating an exemplary mobile communication system using the SMS, according to principles described herein.

FIG. 4 is a block diagram illustrating an exemplary mobile communication system using a proprietary messaging and communication network, according to principles described herein.

FIG. 5 is a flowchart illustrating an exemplary asynchronous mobile authorization process, according to principles described herein.

FIG. 6 is a flowchart illustrating an exemplary asynchronous mobile authorization process, according to principles described herein.

FIG. 7 is a flowchart illustrating an exemplary asynchronous mobile authorization process, according to principles described herein.

FIG. 8 is a flowchart illustrating an exemplary asynchronous mobile authorization process, according to principles described herein.

FIG. 9 is a block diagram illustrating an exemplary mobile communication system, according to principles described herein.

FIG. 10 is a flowchart illustrating an exemplary asynchronous mobile authorization process, according to principles described herein.

FIG. 11 is a flowchart illustrating an exemplary asynchronous mobile authorization process, according to principles described herein.

FIG. 12 is a flowchart illustrating an exemplary asynchronous mobile authorization process, according to principles described herein.

FIG. 13 is a flowchart illustrating an exemplary asynchronous mobile authorization process, according to principles described herein.

FIG. 14 is a flowchart illustrating an exemplary asynchronous mobile authorization process, according to principles described herein.

FIG. 15 is a block diagram depicting an exemplary asynchronous mobile authorization system, according to principles described herein.

FIG. 16 is a flowchart illustrating an exemplary asynchronous mobile authorization process, according to principles described herein.

FIG. 17 is a block diagram an exemplary asynchronous mobile authorization system, according to principles described herein.

FIG. 18 is a flowchart illustrating an exemplary asynchronous mobile authorization process, according to principles described herein.

FIG. 19 is a flowchart illustrating an exemplary asynchronous mobile authorization process, according to principles described herein.

FIG. 20 is depicts a block diagram of a computer system suitable for implementing the present systems and methods.

Throughout the drawings, identical reference numbers designate similar, though not necessarily identical elements.

### DETAILED DESCRIPTION

The present exemplary system and method combat credit card and debit card fraud by leveraging widely adopted wireless communication protocols. Specifically, according to one exemplary embodiment, the present system and method utilizes cellular phones and the short message system (“SMS”) to asynchronously authorize credit and debit card transactions. As used herein, the terms “debit card” and “credit card” shall be used interchangeably to refer to any numerically based instrument that is used for electronic purchase.

The present exemplary system and method also creates further flexibility for credit card use. For instance, a parent may want their child to have a credit card in their wallet at all times in case of an emergency. However, the parent will also likely want to scrutinize any transactions paid for with the card. Similarly, a parent may want their children to learn how to manage an account and to learn the advantages and disadvantages of using credit cards. The present exemplary system and method for asynchronous mobile authorization of credit card purchases enables a parent to be notified of attempted transactions of a designated monetary amount and to authorize or deny the transactions at any location, including locations remote from the point of sale.

Additionally, the present exemplary system and method provides one or more account holders the ability to remotely authorize transactions using their cellular phones. This technique not only reduces fraud and the opportunity for fraudulent activity, but can also be used as a tool for fiscal accountability, where card holders that have previously made poor impromptu purchases or have accrued substantial credit card debt are required to obtain the authorization of at least one other individual prior to completing a transaction that meets a designated price threshold. As will be detailed below, the authorization provided by at least one other individual may be asynchronous to the desired transaction in that it may be provided in a time period prior to a desired transaction or immediately after a desired transaction exceeding pre-defined limits has been denied.

The present specification details exemplary systems and methods for asynchronous mobile authorization of credit card purchases. The systems and methods described herein enable credit card holders, or the account holders of the credit card, to asynchronously authorize credit card purchases in order to protect assets and monitor account behavior, while minimizing cardholder inconvenience, embarrassment, or delay.

While traditional systems for credit card control and/or authorization are dependent on proprietary software being resident on the mobile device and only allow for synchronized authorization at the point of sale, the present exemplary system and method allows account holders to authorize purchases at either the point of sale or at a remote location, thereby adding convenience to the cardholder. Furthermore, the present exemplary system and method provides protection from credit card theft, identity theft, and/or other fraudulent schemes intended to make transactions without the card or account holders' permission. Moreover, the present exemplary system and method allows for multiple account holders to monitor and approve transactions, which is useful in both domestic and commercial settings. Alternate configurations may also include, but are in no way limited to, a tiered authorization structure based on the total purchase price, purchaser, card holder, etc.

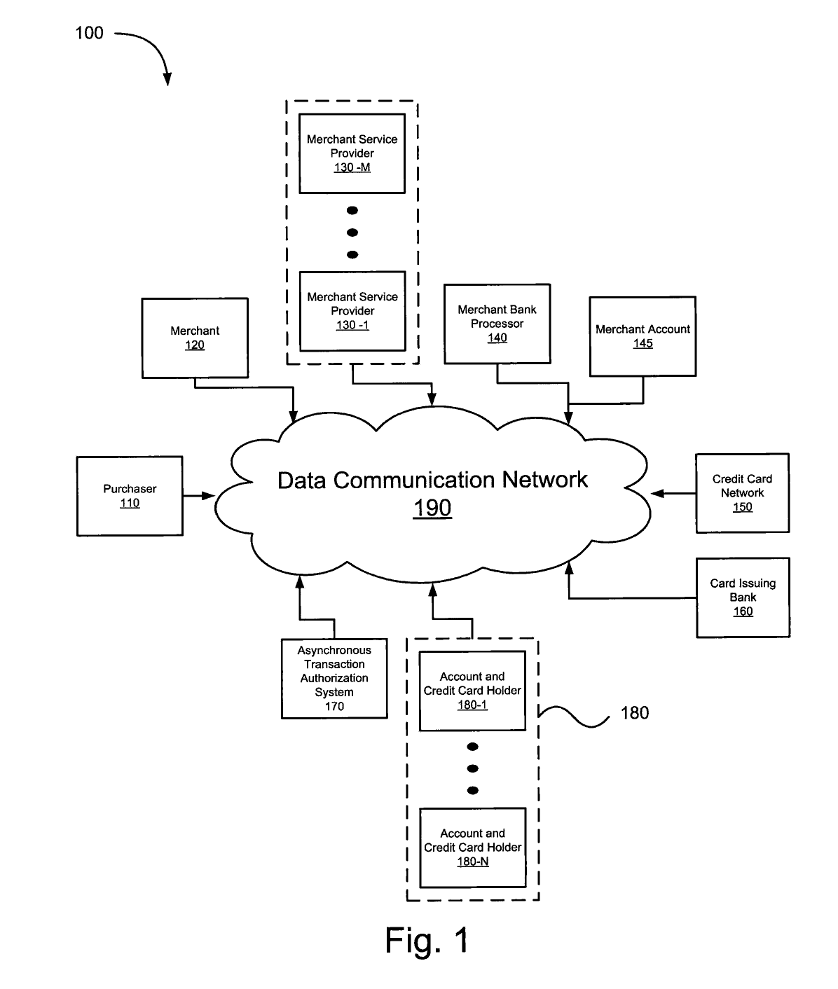

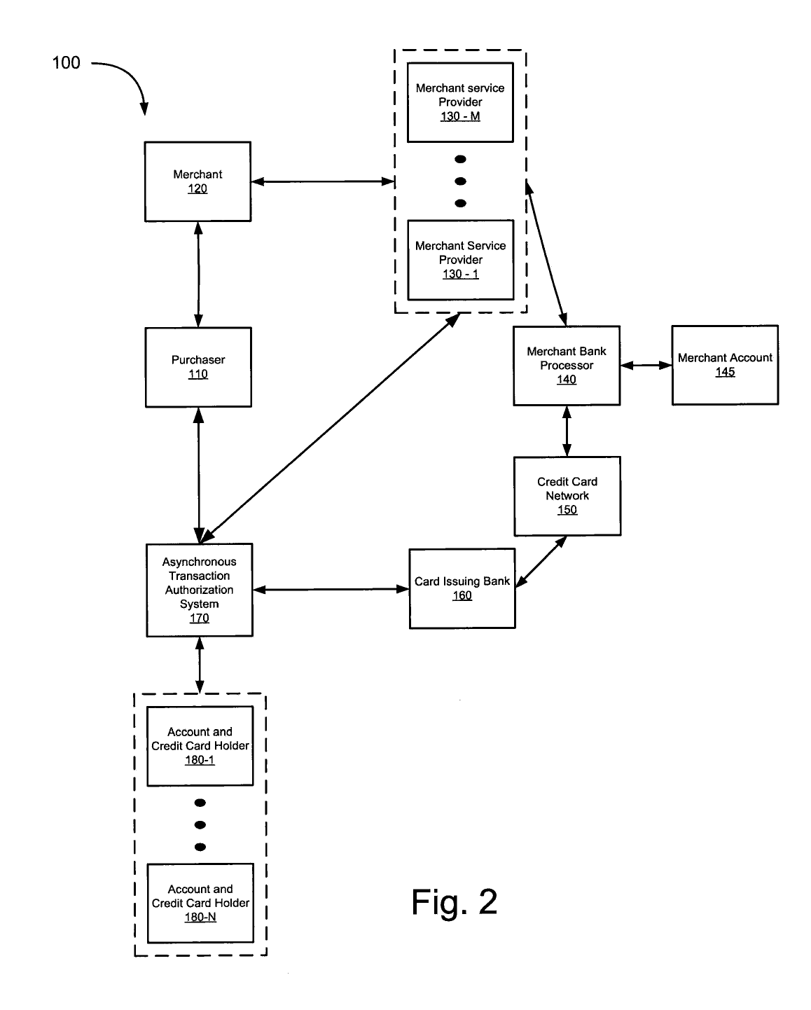

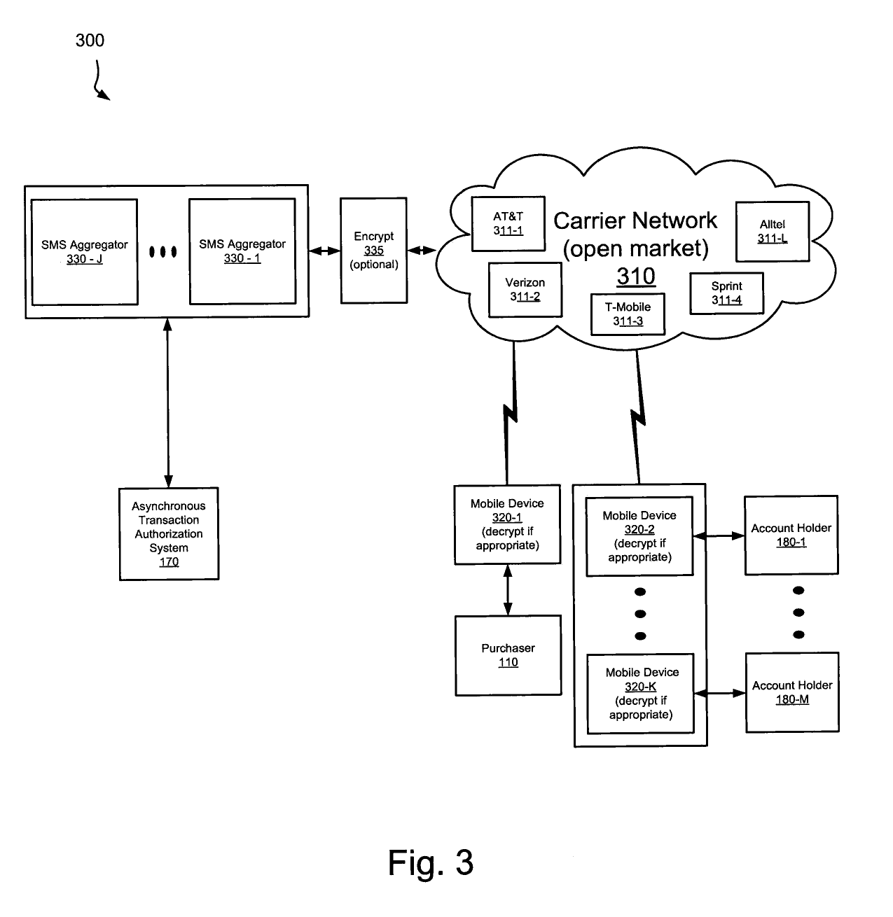

In a domestic setting, as illustrated in FIGS. 1 and 2, a purchaser (110) may be any person that is entrusted with a credit card, including but not limited to a child. According to one exemplary embodiment, the guardians and/or account holders (180) of the card entrusted to the purchaser (110) may require that any purchases over a pre-determined amount, such as fifty dollars, be authorized by an appropriate number of account holders (180). According to the present exemplary system and method, when a purchaser (110), which may also be an account holder (180), anticipates making a purchase that exceeds the pre-determined amount, pre-authorization of the desired transaction may be secured using the present exemplary systems and methods. According to this exemplary embodiment, the purchaser may first obtain the anticipated transaction total, either directly from the merchant (120) or via a separate purchase price accumulator. The purchaser (110) could then, using any number of wireless communication devices including, but in no way limited to an application on a smart phone (ACHD (320; FIG. 3)) or text messaging (the SMS (300; FIG. 3)) on a non-smartphone, obtain pre-authorization of the desired transaction, using the exemplary systems and methods detailed below.

Furthermore, when obtaining pre-authorization of an anticipated transaction, the account holder(s) (180) or purchaser (110) may enter a desired transaction range for approval, rather than a specific amount. The ability to request approval for a desired transaction range adds the convenience of perhaps not requiring all the desired items to be rung up at a register or, for instance, if an unknown amount will be left for a tip or other situation where the exact transaction amount is unknown. According to this exemplary embodiment, receipt of the transaction request by the exemplary system would cause a notification to be transmitted to the account holder(s) (180). The purchaser (110) may also have the ability to include a note that will be provided to the account holder(s) (180) along with the purchase authorization request, e.g., “buying school supplies at Staples. I need a new printer.” The amount requested, and the note may be presented to the account holder(s) (180) for pre-authorization according to the exemplary systems and methods detailed below.

After the account holder(s) (180) approve the transaction via a responsive SMS text message or other similar feature, notification of approval may be sent via text message to the other account holder(s) (180) and/or the purchaser (110). After a predefined number of account holders (180) have granted approval, the card holder/purchaser (110) may be sent a notification via text message that transaction has been authorized.

Alternatively, according to the present exemplary embodiment, when the merchant (120) is requested to initiate a charge with the entrusted credit card and attempts to complete the transaction that exceeds a predefined threshold, e.g., fifty dollars, and no pre-authorization has been obtained, the transaction is initially declined, and submission results are returned to the merchant. According to this exemplary embodiment, the failed transaction exceeding the predefined threshold initiates the transmission of a message to the purchaser (110), such as a text message, notifying the purchaser (110) that authorization of the declined charge is pending. Simultaneously, according to one exemplary embodiment, the account holder(s) (180) also each receive a text message, which may include, but is in no way limited to, the transaction parameters of the recently declined transaction and a query for authorization of a subsequent transaction. The transaction details provided to the account holder(s) (180-1-180-N) may include, but are in no way limited to, the merchant's (120) id or name, the charged card number, card holder name, transaction location, and/or transaction price. The text message may also optionally include a request for a keyword that must be in the account holder's response to approve the transaction.

Again, after the account holder(s) (180) approve the transaction via a responsive SMS text message or other similar feature, notification of approval may be sent via text message to the other account holder(s) (180) and/or the purchaser (110). After a predefined number of account holders (180) have granted approval, the card holder/purchaser (110) may be sent a notification via text message that transaction has been approved.

The purchaser (110) can then instruct the merchant (120) to submit the transaction for a second time. The transaction is again requested by the merchant (120) via a credit card terminal or other computing device transmitting transaction parameters to an appropriate receiving system. Once the follow-up transaction request is submitted, the charge will be approved and the sale consummated because the authorization has been given by an appropriate number of account holders (180). Transaction parameters may include any number of descriptive information related to the desired transaction including, but in no way limited to the merchant id and name, amount of desired transaction and the like. Many times merchants will incorporate large computing systems including multiple processors and thus multiple unique merchant identifiers across the multiple processors. Consequently, merchant identifiers may be correlated with the merchant's (120) name for matching authorization with the second transaction request.

Thus, the present exemplary systems may be used to track authorized purchases by family members. It may also be used to prevent fraudulent purchases above a designated threshold by those who have stolen either an account holder's (180) card or card information.

These and other uses and benefits of the exemplary systems and methods described herein will become apparent upon consideration of the following examples.

### I. Exemplary System View

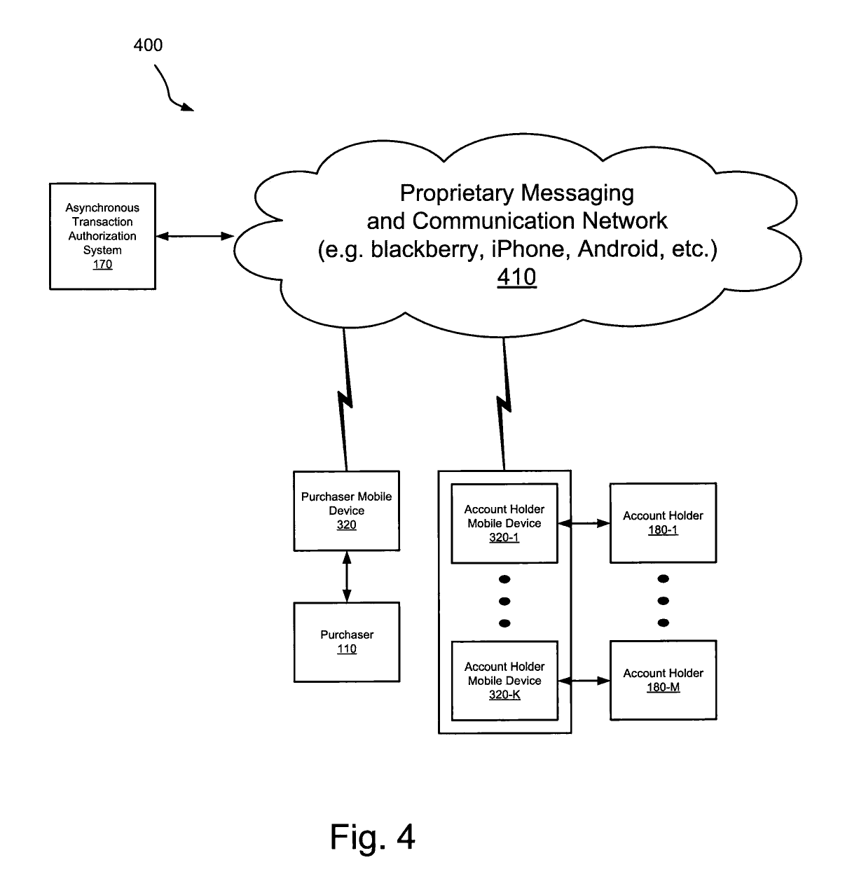

FIG. 1 and FIG. 2 illustrate exemplary asynchronous mobile authorization systems (100) incorporating the present exemplary system and method for asynchronous mobile authorization. As shown in FIG. 1, the present exemplary system (100) may include a purchaser (110), a merchant (120), a merchant service provider (“MSP”) (130-1-130-M) (collectively referred to as “MSPs (130)”), a merchant bank processor (“MBP”) (140), a credit card network (“CCN”) (150), a card issuing bank (“CIB”) (160), an asynchronous transaction authorization subsystem (“ATA”) (170), and account or card holder (“ACH”) devices (180-1 through 180-N) (collectively “ACHs (180)”). In some examples, all persons, modules, and subsystems may communicate using any known communication technologies, devices, media and protocols supportive of remote communications, including but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The purchaser (110), CCN (150), CIB (160), and ACHs (170) may communicate over any number of technologies including, but in no way limited to, the SMS (300; FIG. 3) and proprietary messaging and data systems (400; FIG. 4).

Through ACH devices (180-1-180-n), e.g., mobile phones, the purchaser (110) and ACHs (180) may be provided with notification of pre-purchase authorization requests, attempted purchases, notification of authorization, notification of each party providing authorization, providing authorization, notification of authorization expiration, and submitted transactions via the ATA (170). The results may be published to any appropriate combination of the purchaser (110), merchant (120), MSPs (130), MBP (140), CCN (150), CIB (160), ATA (170), ACHs (180), and the ACHDs (320). Elements and functions of the exemplary system (100) of FIG. 1 will now be described in additional detail below.

A. Purchaser (110)

The purchaser (110) illustrated in the system of FIG. 1 may be any person attempting to purchase goods or services from a merchant (120) with a credit or debit card. According to one exemplary embodiment, a purchaser (110) includes, but is in no way limited to, an account and credit card holder (180), an authorized agent of an ACH (180), or a fraudulent user of a credit card owned by ACHs (180), and may be initiated via online purchases, in-store purchases, and/or remote caller purchases.

B. Merchant (120)

A merchant (120) may be any physical, on-line, phone, or otherwise accessible entity that sells goods or services to the purchaser (110). Popular merchants include, by way of example only, Wal-Mart Stores, Inc., Foot Locker, Inc., and Amazon.com, Inc. According to one exemplary embodiment, a merchant is registered, and makes transactions through, one or more MSPs (130-1-130-M). Prior to accepting credit card transactions, a merchant (120) creates a merchant bank account (145) and then registers the account with one or more merchant MSPs (130-1-130-M). Once established, the merchant (120) can submit a credit card transaction to the MSP (130-1-130-M) on behalf of a customer via secure Web site connection, retail store, MOTO center or wireless device.

A merchant (120) may include or be associated with one or more networks suitable for carrying communications between the merchant (120), and the MSP (130-1-130-M). For example, the merchant (120) may be communicatively coupled to the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the merchant (120) and the MSP (130-1-130-M).

C. Merchant Service Providers (“MSP”) (130-1-130-M)

An MSP (130-1-130-M) provides an interface for real-time credit card processing to a merchant (120). Examples of some popular MSPs (130-1-130-M) include, by way of example only, Authorize.Net, Paypal, and Beanstream Internet Commerce Corp. Many banks that provide merchant accounts also operate as merchant service providers. An MSP (130-1-130-M) receives secure transaction information from a merchant (120) and passes it via a secure connection to the merchant bank processor (140). The MSP (130-1-130-M) may be communicatively coupled to one or more networks suitable for carrying communications between the merchant (120), and the MBP (140). For example, the MSP (130) may be communicatively coupled to any network including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the merchant (120) and the MBP (140).

D. Merchant Bank's Processor (“MBP”) (140)

As illustrated in FIG. 1, the Merchant Bank's Processor (140) is associated with a bank and provides access to a merchant account (145). Popular MBPs (140) include, by way of example only, Wells Fargo, N.A., Citigroup, Inc., and many other companies which may provide an interface for real-time credit card processing. Many banks that provide merchant accounts are also MBPs (140). The MBP (140) receives a transaction request and submits the transaction to the CCN (150) for authorization and processing. The MBP (140) may be communicatively coupled to one or more networks suitable for carrying communications between the MSP (130), and the CCN (150). For example, the MBP (140) may be communicatively coupled to, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the MSP (130) and the CCN (150).

E. Merchant Bank Account (145)

The popular merchant banks detailed above, including Wells Fargo, N.A., Citigroup, Inc., and many other companies, offer merchant bank accounts (145) that provide similar features and services, when compared to personal bank accounts, but also typically enable real-time credit card deposits and withdrawals. A merchant bank account (145) may be established and be configured to be accessed and communicate via one or more networks suitable for carrying communications between it and the MBP (140) including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between it and the MBP (140).

F. Credit Card Network (CCN) (150)

As illustrated in FIG. 1, the CCN (150) is a system of financial entities that communicate to manage the processing, clearing, and settlement of credit card transactions. The CCN (150) routes a received transaction to the Customer's CIB (160) for approval and further processing. The system of financial entities that function and/or operate in the credit card network (150) may include, but are in no way limited to, Visa, Inc., MasterCard, Inc., and American Express Company. According to one exemplary embodiment, the CCN may be a processor, a server, or any number of dedicated servers that receive credit card transaction requests, identify the card issuing bank associated with the credit card transaction request, and facilitate communication of the credit card transaction request with the card issuing bank (160). Communication between the CCN, and any other entity illustrated in FIG. 1 may be accomplished via one or more networks suitable for carrying communications including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the elements illustrated in FIG. 1.

G. Card Issuing Bank (“CIB”) (160)

A CIB (160) is any financial institution, including banks, credit unions, corporations, stores, and the like, which issue the credit card to the ACH (180). Popular CIBs (160) include Wells Fargo, N.A., Citigroup, Inc., JPMorgan Chase & Co., and any other companies that provide credit cards from Visa, Inc., MasterCard, Inc., and American Express Company. Prior to the current system, the CIB (160) was one of the only entities in the transaction process which approved or declined a requested transaction based on the customer's available funds. The CIB would then historically pass the transaction results back to the CCN (150) for further action and/or inaction. In the present exemplary system and method presented, the CIB (160) still approves or declines settlement of credit card transactions, however before final approval, the CIB (160) routes the transaction to the ATA (170) for initial approval.

Similar to the communication details mentioned above, the CIB (160) may be communicatively coupled to one or more networks suitable for carrying communications between the CCN (150) and the ATA (170). For example, the CIB (160) may be communicatively coupled to, but is not limited in its communication connection to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between the CCN (150) and the ATA (170).

H. Asynchronous Transaction Authorization Subsystem (“ATA”) (170)

According to one exemplary embodiment of the present exemplary system and method illustrated in FIG. 1, an asynchronous transaction authorization subsystem may form an integral component of the asynchronous mobile authorization systems (100). According to the present exemplary system, the ATA (170) may be configured to give approval of a submitted or anticipated transaction that exceeds a predefined threshold only after sufficient ACHs (180) have given approval. The ATA (170) may be included in or reside with, but is in no way constrained to exist within the CCN (150) or the CIB (160), as an inline filter before or after the CCN (150) or the CIB (160). Alternatively, the ATA may exist as a third-party system interfacing with any modules or systems within the credit card authorization process (100) and acting as a clearing house for various transactions based on the thresholds provided.

According to one exemplary embodiment, regardless of the physical location of the ATA, the ATA (170) also may include, but is not limited to one or more servers with software to interface with one or more CIBs (160), one or more SMS aggregators, and electronic storage devices.

Accordingly, those skilled in the art will recognize that the processes described herein may be implemented at least in part as instructions executable by one or more computing devices. In general, a processor (e.g., a microprocessor) receives or otherwise accesses instructions, e.g., from a data storage device, memory, computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, solid state drives, any other memory chip or cartridge, or any other medium from which a computer can read.

Furthermore, as illustrated in FIG. 1, the ATA (170) may communicate with the present exemplary system via a data communication access which may include, but is in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, multimedia messaging service (“MMS”), simple mail transfer protocol (“SMTP”), proprietary communication network via mobile device manufacturer (e.g., iPhone, Blackberry, and Android) proprietary networks for sending and receiving message or instructions (410) and any other communications networks capable of carrying communications between the purchaser (110), CCN (150), CIB (160) and the ACH (180).

I. Account or Authorized Card Holders (“ACH”) (180)

As noted previously, an account or authorized card holder is any person that owns or shares ownership of an account and is at least partially responsible for its funds. The ACH (180) may, but is in no way limited to, interface through the SMS (300; FIG. 3), PMMCN (410; FIG. 4), or ACHD (320; FIG. 3). The ACH may, but is in no way limited to communication with any module, subsystem, or class within the system (100).

As noted above, a mobile phone or any computing device including a hand-held computing device may be used to facilitate the access of ACH to the system (100). According to one exemplary embodiment, the ACH (180) interacts with the present system (100) via SMS and/or MMS messaging. FIG. 3 is an exemplary cellular communication system (300) configured to send and receive SMS and MMS messages via the carrier network in order to facilitate the present exemplary system and method. As shown in FIG. 3, the cellular communication system (300) may include a carrier network (310) configured to communicatively couple a purchaser (110), an asynchronous transaction authorization subsystem (“ATA”) (170), account or card holder (“ACH”) devices (180-1 through 180-N) (collectively “ACHs (180)”), and mobile device (320-1 through 320-K) (collectively “mobile devices (320)”). In some examples, all persons, modules, and subsystems may communicate using any known communication technologies, devices, media and protocols supportive of remote communications, including but not limited to, transmission media, communications devices, Transmission Control Protocol (“TCP”), Internet Protocol (“IP”),File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The cellular communication system (300) will be discussed below.

J. Mobile Device (“ACHD”) (320)

According to one exemplary embodiment, the account or authorized card holder device (320) illustrated in FIG. 3 is any mobile computing device which may include, but is not limited to a blackberry, an iPhone, a PDA, a Nintendo DS, or any other mobile device that can send and receive messages over the SMS (300) or propriety messaging network (400). The ACHD (320) may have access to one or more networks suitable for carrying communications between it and the ATA (170). For example, the ACHD (320) may have access to, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between it and the ATA (170), the cellular communication system (300), PMMCN (410), or ACH (180).

K. Carrier Network (Open Market) (310)

According to the exemplary illustrated embodiment, the present exemplary system may facilitate communication between the purchaser, the ATA (170) and the ACH (180) via a carrier network (310). According to one exemplary embodiment, the carrier network may include, but is in no way limited to, cellular service providers, e.g., AT&T (311-1), Verizon (311-2), T-Mobile (311-3), Sprint (311-4), and Alltel (311-L). The carrier network is a system of cellular providers which are responsible for connection, delivery of data, and service for one or more ACHDs (320). The carrier network (180) may include one or more networks suitable for carrying communications between the ACHDs (320) and the SMS Aggregators (330). For example, the carrier network (310) may access the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between the ACHDs (320) and the SMS Aggregators (330). Interfacing directly with the carrier network can be both costly and time consuming and therefore, may be abstracted away, through SMS aggregators (330).

L. SMS Aggregator (330)

SMS aggregators, such as CellTrust, Inc., Click-a-tell (Pty) Ltd., and MobyQ, LLC provide an interface for computing devices to send and receive messages via the SMS, without direct connection to the carrier network (310). These services typically offer high throughput and statistics that would normally be unavailable through an ACHD (320). An SMS aggregator (330) may communicate via any network suitable for carrying communications including, but in no way limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, SMS, MMS, SMTP, and any other communications networks capable of carrying communications between the ATA (170) and the ACHDs (320).

M. Encrypt (335)

According to one exemplary embodiment, in order to maintain security of the present exemplary system, the data communications that are transmitted between the various components of the system (100) are encrypted. The encryption and decryption of a message via the SMS, or any message over the carrier network (310) are typically processed independently. The SMS protocol does not typically implement any additional encryption to secure messages between ACHDs (320), SMS aggregators (330), or the ATA (170). Prior work using encryption over SMS or the PMMCN (410) has been documented. It is an industry standard in the financial sector to incorporate encryption mechanisms between mobile/remote access points, therefore the ATA system may, but is not required to do so as well.

FIG. 4 illustrates an exemplary proprietary mobile data and communication system (400), according to one exemplary embodiment. As shown in FIG. 4, the proprietary mobile data and communication system (400) may include a purchaser (110), an asynchronous transaction authorization subsystem (“ATA”) (170), account or card holder (“ACH”) (180-1 through 180-N) (collectively “ACHs (180)”), device (320-1 through 320-K) (collectively “mobile devices (320)”), and a proprietary mobile messaging and communication network (410). In some examples, all persons, modules, and subsystems may communicate using any known communication technologies, devices, media and protocols supportive or remote communications, including but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communications technologies (e.g., cellular telephone and wireless access technologies), and any other suitable communications technologies. The proprietary mobile data and communication system (400) will be discussed below.

N. Proprietary Mobile Messaging and Communication Network (“PMMCN”) (410)

The proprietary mobile messaging and communications network (410) illustrated in FIG. 4 enables the present exemplary system and method to be conducted over a proprietary network. Specifically, the PMMCN (410) is a system of proprietary messaging and data service providers which are responsible for connection, delivery, and service of one or more ACHDs (320). According to one exemplary embodiment, the PMMCN (410) includes, but is in no way limited to mobile device developers and manufacturers, e.g., Apple (iPhone and iPod Touch), Blackberry, Google (Android), Nintendo (Nintendo DS), etc that enable communication between devices. The use of the PMMNCN (410) allows the ATA to communicate with proprietary applications which run locally on an ACHD (320), but may provide enhanced functionality not normally available through the SMS. Such applications and features may include, but are in no way limited to, bar codes scanners implemented in iPhone and Android applications, as will be described in further detail below.

### II. Exemplary Process Views

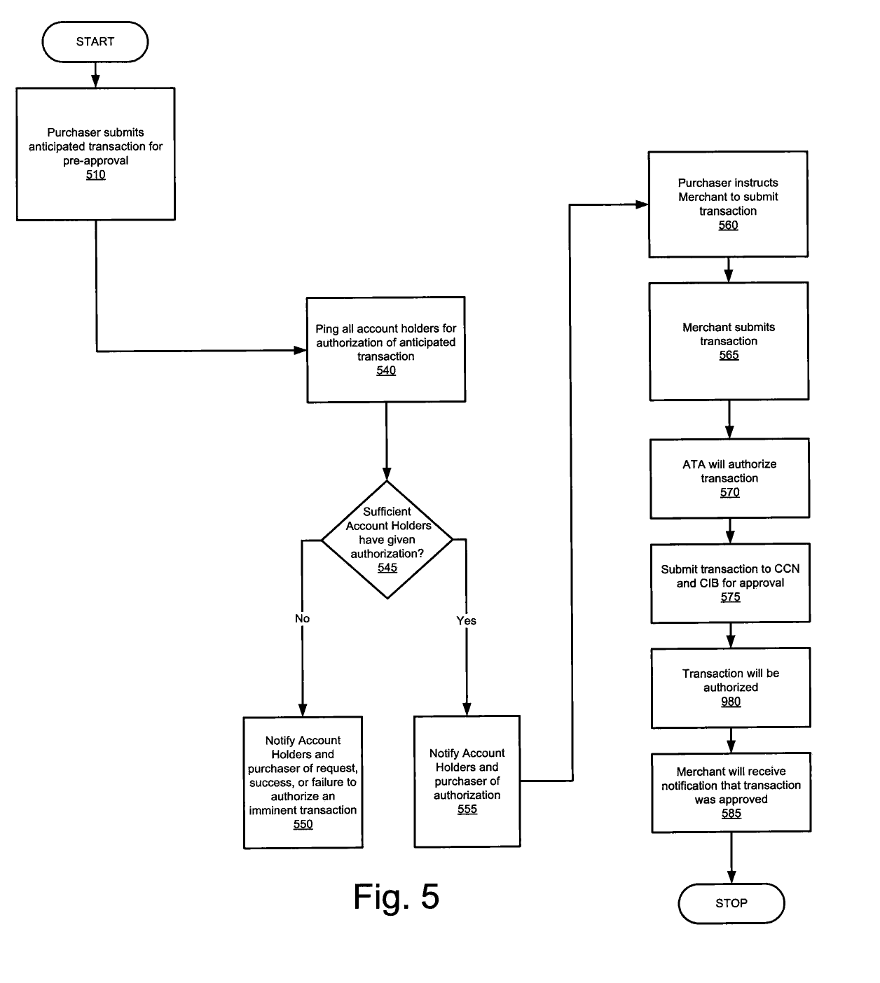

FIG. 5 illustrates an exemplary process for pre-authorizing a transaction that exceeds a predetermined threshold using the ATA system, according to one exemplary embodiment. While FIG. 5 illustrates exemplary steps according to one embodiment, other embodiments may selectively omit, add to, reorder, and/or modify the steps shown in FIG. 5.

As shown in FIG. 5, when a purchaser (110) has identified a desired transaction that exceeds the predetermined threshold amount, the purchaser seeks pre-approval of the desired transaction by submitting the transaction amount to the present exemplary system (step 510). Optionally the purchaser (110) may submit a range, or a series of prices for which the sum should equal the amount of the anticipated transaction. Once the transaction amount has been received by the ATA (170), the ATA will ping the ACHs (180) for approval (step 540). As noted above, when the ACHs (180) are contacted for their approval of a proposed transaction, any variation of information may be provided. According to one exemplary embodiment, the transaction authorization request may include any combination of, but is in no way limited to, the transaction amount, merchant information, a description of products being purchased with the transaction, a personalized message, and the like. In response to the ping sent to the ACHs (180), the ATA may initiate a timed session wherein approval must be provided by a predetermined number of ACHs (180) or the ATA will decline the pre-authorization.

Regardless of whether or not a session is initiated, the ATA will monitor responses and determine if sufficient ACHs (180) have provided authorization (step 545). According to this exemplary embodiment, account holders may establish a pre-determined number of ACH authorizations that are needed to authorize a transaction over the pre-determined threshold. Based on the pre-determined ACH authorization level, the ATA (170) verifies that sufficient ACH approvals have been received (step 545). If an insufficient number of ACH approvals have been received by the ATA (No, step 545), the ATA notifies the ACHs (180) and the purchaser (110) that the pre-authorization has been declined (step 550). According to one exemplary embodiment, the ATA (170) may, if insufficient ACH authorizations have been received, remind non-responsive ACHs (180) of the request and responses by other ACHs (180). Upon subsequent ACH responses, step 545 can repeated, and step 550 will be repeated until all required ACHs (180) have given approval, declined, or the session times out.

If sufficient ACHs (180) have given authorization (Yes, step 545), the ACHs and the purchaser are notified of the pre-authorization (step 555). According to one exemplary embodiment, if the ATA is implemented as part of the CIB (160), the CIB (160) may, in addition to returning information related to the pre-approval of the transaction by the ACHs (180), return information related to whether the anticipated transaction would be approved, denied, or create an overdraft situation based on a lack of funds or other management reason the CIB (160) might provide.

Continuing with FIG. 5, once the purchaser (110) receives notification that the anticipated transaction is authorized (step 555), the purchaser (110) will instruct the merchant (120) to submit a transaction (step 560). When the transaction is submitted by the merchant through the MSP (step 565), the submitted transaction parameters should correspond to the transaction details used for pre-authorization. If the parameters are not substantially the same, or are not submitted within a predefined amount of time from the pre-authorization notification, the transaction will also be declined.

If, however, the parameters of the merchant submitted transaction are sufficiently similar to the originally submitted pre-authorization transaction information (as compared by the ATA), and within a designated period of time, the ATA will authorize the transaction (step 570) and allow the CCN (150), CIB (160), or any other module or subsystem interfacing with the ATA (170) to verify that all other parameters are in line for approval of the transaction (step 575). While the present exemplary system is described as requiring ATA approval of transaction exceeding the predetermined amount prior to passing the transaction on to the CCN (150) and/or CIB (160), such as if the ATA functioned as a standalone clearinghouse, The ATA (170) may be resident with the CCN or CIB, approval by the ATA may occur either prior to or after approval by the CCN and/or CIB.

Once approval is obtained by the ATA, the CCN, and the CIB, the transaction will be authorized and funds may be transferred to merchant account (step 580). Accordingly, the transaction will be approved at the point of sale and the merchant (120) will receive notification that the transaction has been approved and/or completed (step 585). Once completed, the purchaser may obtain the items being purchased.

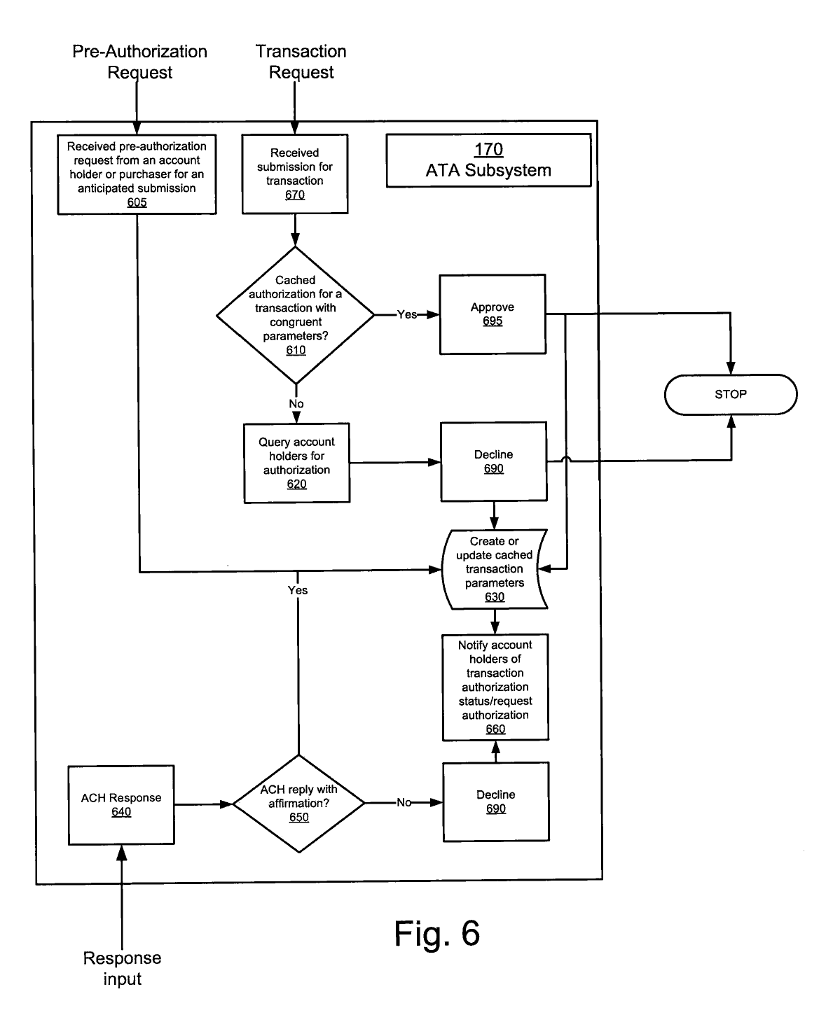

In order to provide further detail of the ATA process, FIG. 6 illustrates an exemplary ATA process, according to one embodiment. While FIG. 6 illustrates exemplary steps according to one exemplary embodiment, other embodiments may omit, add to, reorder, and/or modify any of the steps shown in FIG. 6.

As illustrated in FIG. 6, pre-authorization of any transaction may be given by any number of ACHs (180) to the ATA (170) before any transaction that exceeds a pre-defined threshold is approved (step 605) (if operating as a standalone clearing house) or through the CCN (150) or the CIB (160) as either an internal system to the CCN (150) or the CIB (160) or as an inline filter before or after the CCN (150) or the CIB (160) (step 610). Pre-authorization is initiated by a pre-authorization request, which may be submitted by a purchaser or an ACH(s) via an ACHD (320) (step 605). When a request for pre-authorization is provided for a transaction that exceeds the pre-determined threshold amount, the ATA (170) will create a new record and/or session with the anticipated transaction parameters (step 630), which may include, but is in no way limited to, the anticipated price of the transaction or a range within which the anticipated transaction will fall. Next, the ATA (170) will lookup whether or not authorization is needed by other ACHs (180), and either a notification of authorization or a request for authorization will be sent to the ACHs (180) step (660). In this exemplary embodiment, pre-authorization may be initiated by the ACHs (180) for a known transaction or it may be requested by a purchaser (110).

If, after analyzing the pre-authorization request, the ATA determines that authorization by additional ACHs is needed to meet the threshold authorizations, that authorization is sought (step 660) and upon receipt of the ACHs (180) authorization, (step 640), the ATA (170) will verify that the response was an affirmative authorization (step 650). If the response from the other needed ACHs is affirmative (yes, step 650), the ATA (170) updates the cached record of the anticipated transaction parameters (step (630). If, however, the response from the remaining ACHs (180) is negative or insufficient to meet the pre-determined number of ACHs approvals, authorization will be declined (No, step 690). Regardless of the authorization results, the ACHs and/or the purchaser may be notified of the results (step 660).

When the ATA (170) receives a submission for a transaction by a merchant (step (670), the ATA (170) will attempt query for an active (meaning not expired due to time delay) record which has been authorized and has congruent parameters with the received submission for transaction (step 610). If the ATA (170) finds a record corresponding to the received submission for transaction that has been authorized, the submission is said to have been anticipated and authorized, and is approved (step 695), and the record is updated (step 630). Thus if another transaction is attempted, for the same price, then the submission will be denied, since a transaction was already approved with the transaction parameters.

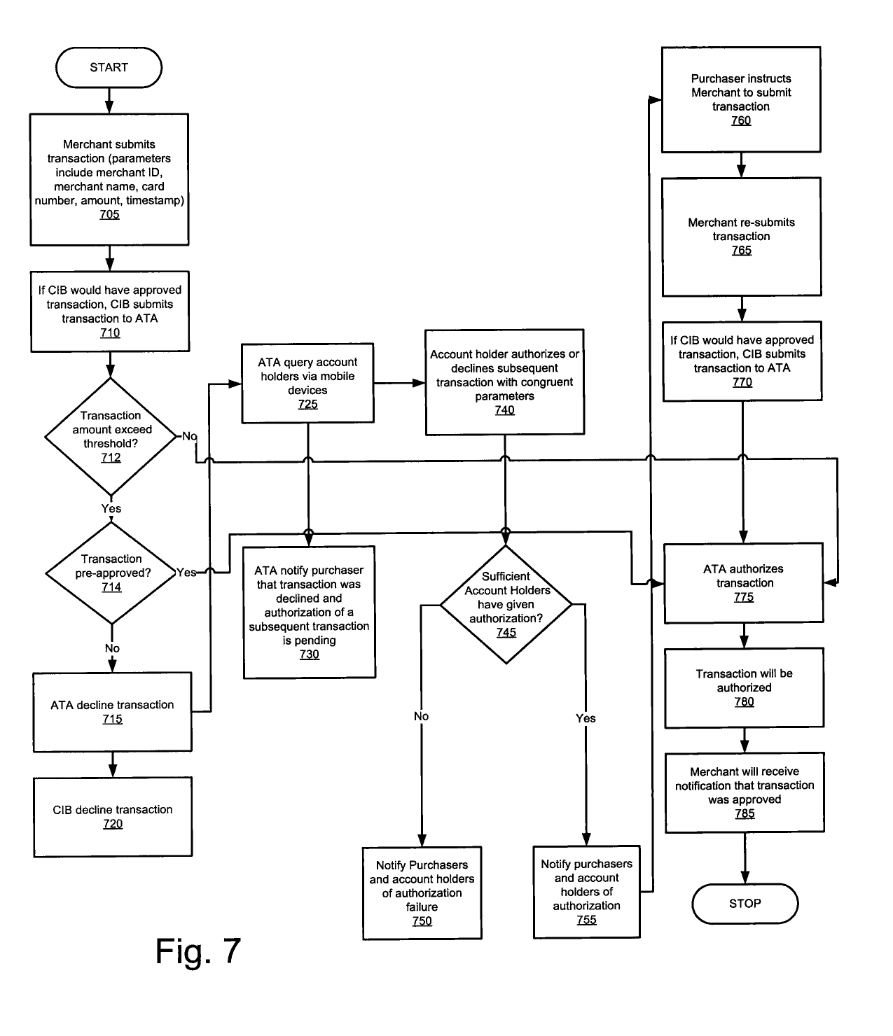

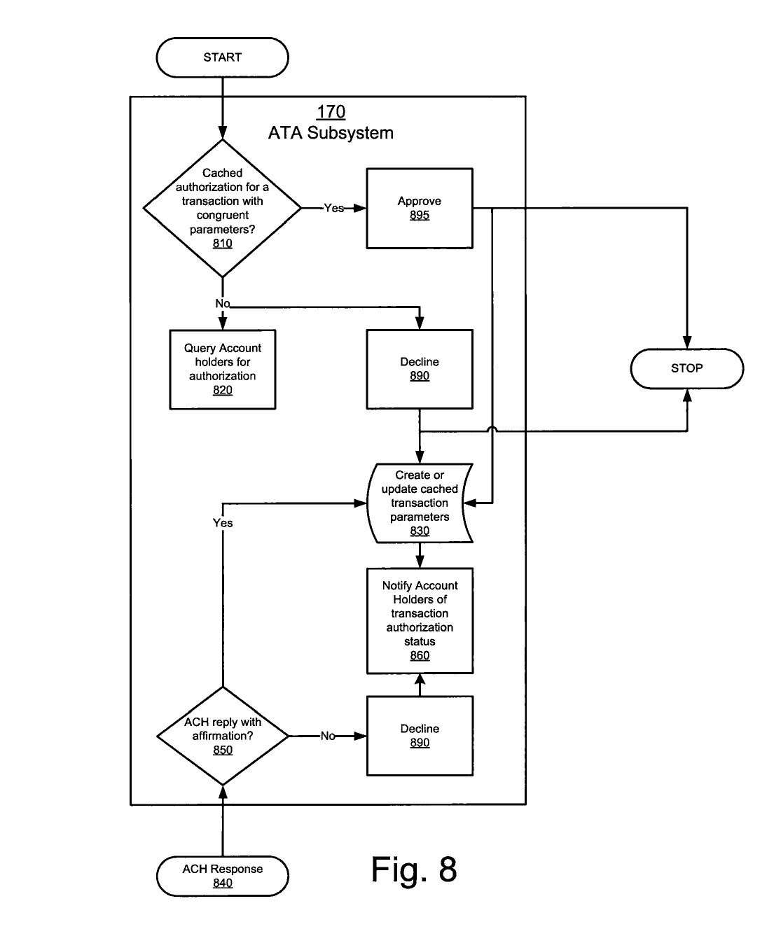

If, however, the ATA (170) receives a submission for a transaction exceeding the pre-defined threshold and finds no corresponding active record of authorization, then the ACHs (180) will be queried for authorization (No, step 620), and the submission will initially be declined (step 690). If there is no record of an authorization with parameters matching the submission parameters, then a record will be created with the submitted transaction's parameters (step 630). Then, the ACHs (180) will be notified of the transaction (step 660) to take remedial actions in the case of fraudulent activity, or to proceed with providing post transaction approval, as is detailed below with reference to FIGS. 7 and 8.

FIG. 7 illustrates an exemplary ATA process, according to one exemplary embodiment. While FIG. 7 illustrates exemplary steps according to one embodiment, other embodiments may selectively omit, add to, reorder, and/or modify the steps shown in FIG. 7.

As noted above, purchasers may request a transaction, either unintentionally or as an alternative to pre-approval, that exceeds the predetermined threshold and that has not received pre-approval. Consequently, the transaction will be declined and post transaction approval will be sought. As shown in FIG. 7, a merchant (120) initially receives a request to complete a transaction and subsequently submits a transaction for approval by the CCN (150), CIB (160), and ATA (170) (step 705). The parameters in the submission made by the merchant (120) may include, but are in no way limited to the merchant's ID or name, amount of money requested for the purchase, credit card information, and a timestamp. The merchant ID is a number assigned to the merchant by the merchant's MSP (130). However, amongst larger merchants it is common to have several MSP (130) accounts for redundancy and failsafe mechanisms. Each MSP (130) can assign an arbitrary merchant id to each merchant (120). Therefore, since some merchants (120) may submit a transaction for approval using one MSP (130) and then use a different MSP (130) for a subsequent submission, the merchant name, as well as the merchant ID, may be equally important to track. The timestamp of the submission is used to ensure that a subsequent submission is within a predefined amount of time. Subsequent submissions that occur after the predefined time period will not be correlated or associated with each other, and will be treated as a separate purchases. While it is also likely that the ATA (170) may not rely on this timestamp, however, it may be useful for other features including but not limited to testing and data integrity metrics.

Once the transaction is submitted from the merchant (120), the CCN (150), CIB (160), and/or ATA (170) will receive the submission from the merchant (120). In the present example, for ease of explanation, the ATA will be described as residing on the CCN (150) and CIB (160), the ATA (170) may operate within, or as pre- or post-filter, or as a third-party. Furthermore, the ATA (170) is not restricted to any specific module or subsystem, and may be included, or communicated to, by any module or subsystem in the system (100). Therefore, the submission received may be carried to a separate network, or be executed on an existing network or system within any module or subsystem in the authorization system (100).

If the requested transaction does not exceed the predetermined threshold amount, the ATA will allow the transaction to pass through and be acted upon by the CCN (150) and the CIB (160) as processed by traditional systems.

However, if the transaction amount exceeds the predetermined threshold and no pre-approval has been sought, the ATA will be activated and the ATA will decline the first submission for a transaction (step 715). In conjunction with declining the first transaction, the ATA will also decline the submission for the proposed transactions to the CIB (step 720). The declined submission may be returned to any module which interfaces with the ATA (170), and may include but is in no way limited to the CCN (150) and the CIB (160). Declining of the first transaction while authorization is sought is significant in that it frees up the point of sale transaction components (such as credit card processing devices, PIN pads, cash registers, and the like) utilized by the merchant. This allows the merchant to continue to transact business while the present exemplary system seeks authorization. In contrast, traditional systems would take the entire bandwidth of the point of sale transaction components until approval/decline is received or the process times out. Traditional charge approval systems time out within seconds—much too quickly to allow for synchronous cardholder approval of a charge.

Additionally, the ATA (170) will query the account holder(s) via ACHDs (320). Prior to sending the query, the ATA (170) will store and maintain a record of the declined transaction submission. The ATA (170) may, but is not limited to, recording all the parameters discussed above in step 705 related to the declined submission. The record may also include a link to all associated ACHs (180) on the credit card. Furthermore, the record may also record the authorization or denial of each ACH (180). The record may be, but is not limited to, storage on an electronic storage device built to store and archive large segments of data, or an electronic storage device specifically built to create, recall, and update data quickly. Electronic storage devices which are specifically built for speed often provide a limited ability in the amount of data stored, however a caching mechanism using both types of devices may be useful for record keeping, and efficient processing of millions of submissions per minute world wide. The ATA (170) will send the query via the SMS (300), carrier network (310), or PMMDN (410) to the ACHs (180) for response (step 925). The query sent to the ACH (180) via the ACHD (320) may be transmitted via the cellular communication system (300), the proprietary mobile data and communication system (400), or any other communication system. As mentioned previously, the ATA queries the account holders via their mobile devices in order to obtain their authorization for the transaction that exceeded the predetermined threshold value. According to one exemplary embodiment the query received by the account and credit card holder (180) is in the form of an SMS message. Alternatively, the query may include embedded code that allows the ACH (180) to merely select a GUI (graphical user interface) button or other indicator to authorize the transaction.

Along with the query transmitted to the account and credit card holder (180), the ATA (170) may notify the purchaser (110) and/or the merchant that transaction submission was declined due to insufficient funds or another reason (step 730). Alternatively, the purchaser (110) associated with the card used may receive a message informing them that the transaction was declined only because authorization from ACHs (180) is pending (step 730). This step provides further card security in the case of an identity or card theft. Specifically, a person that steals a card or card number and then attempts a purchase that exceeds the predetermined threshold will only be notified by the merchant that the transaction did not go through. They will not receive the notice from the ATA (170) that authorization is pending. Consequently, the criminal attempting to misuse the card will likely assume that the theft had been reported and the card deactivated. Furthermore, other modules and subsystems may use the ATA to notify the purchaser (110) or the ACHs (180) of the status of the submitted transactions.

Once the appropriate queries and notices have gone out, the contacted ACH (180) authorizes or declines a subsequent transaction via an ACHD (320) (step 740). This process may, but is in no way limited to the following exemplary protocols. The ACH may respond to notification from step 725, with an affirmative SMS message containing the word “yes,” or “y,” a predefined keyword, a dynamic keyword provided in the query from step 725, a dynamic graphical user interface that simulates the clicking of a button, or any other forms of electronic acceptance or denial via the SMS (300), PMMDN (410), or proprietary applications defined prior to the ACH receiving the query (step 725).

After sending out the queries, the ATA (170) then awaits the responses from the ACHs. As illustrated in FIG. 7, the ATA (170) stores response from the ACH (180) to the query and determines if sufficient ACHs (180) have responded with authorization (step 745). According to one exemplary embodiment, the certification of an approval from the ACH (180) may be performed by matching an approval message with the ACH's corresponding phone number, by the receipt of a dynamically generated keyword or code that corresponds to the specific ACH and transaction, by the receipt of approval along with a cookie or other tracking kernel that may be associated with the response, and similar technologies. As noted previously, the present exemplary system and method may be configured to authorize a transaction exceeding a predetermined amount if a predetermined number of affirmative responses are received by the ATA. The appropriate amount of responses sufficient for authorization may be set by the user, and may also require authorization from the purchaser to prevent fraudulent transactions.

Regardless of whether the transaction is authorized or declined by the ACHs, a notification may be sent to the purchaser (180), and all other ACHs (180) that a sufficient number of ACH (180) has authorized or declined a subsequent submission of the transaction (step 750). Again, this notification may, according to one exemplary embodiment, be sent via SMS or MMS. In response to the authorization notice, the purchaser (110) or the ACHs (180) may then take appropriate and immediate action since they are on notice that the credit card is being used, whether fraudulently or without permission. Throughout this process funds remain protected.

When the ATA receives sufficient authorizations (Yes, step 745), the ATA may send a response to the purchaser (110) and all ACHs (180) that authorization of a subsequent transaction with similar parameters has been given (step 755).

As the purchaser is now notified that a subsequent transaction is authorized, the purchaser can (110) instruct the merchant (120) to resubmit transaction (step 760). When the transaction is again submitted by the merchant through the MSP (step 765), the afore mentioned parameters from step 705 should be the same, with the possible exception of the merchant ID for large merchants. If the parameters are not substantially the same, or are not re-submitted within a predefined amount of time, the subsequent transaction will also be declined.

If, however, the parameters of the subsequently submitted transaction are sufficiently similar to the originally submitted transaction (as compared by the ATA), and within a designated period of time, the ATA will authorize the transaction (step 770) and allow the CCN (150), CIB (160), or any other module or subsystem interfacing with the ATA (170) to verify that all other parameters are in line for approval of the transaction (step 775). The present exemplary system is described as requiring ATA approval of transaction exceeding the predetermined amount prior to passing the transaction on to the CCN (150) and/or CIB (160). However, as the ATA may be a standalone clearing house application or may be resident with the CCN or CIB, approval by the ATA may occur either prior to or after approval by the CCN and/or CIB.

Once approval is obtained by the ATA, the CCN, and the CIB, the transaction will be authorized and funds may be transferred to merchant account (step 780). Accordingly, the transaction will be approved at the point of sale and the merchant (120) will receive notification that the transaction has been approved and/or completed, similar to prior methods (step 785). Once completed, the purchaser may obtain the items being purchased.

In order to provide further detail of the ATA process, FIG. 8 illustrates an exemplary ATA process. While FIG. 8 illustrates exemplary steps according to one embodiment, other embodiments may omit, add to, reorder, and/or modify any of the steps shown in FIG. 8.

As illustrated in FIG. 8, submission of a transaction by the merchant (120) is given either directly to the ATA (if operating as a standalone clearing house) or through the CCN (150) or the CIB (160) as either an internal system to the CCN (150) or the CIB (160) or as an inline filter before or after the CCN (150) or the CIB (160) (step 810). Authorization of a transaction is requested when a merchant (120) submits a transaction for goods or services to be purchased by the purchaser (110). When a transaction is requested, a query may be performed to identify a prior submission according to the merchant's (120) id and/or name, price of the transaction, time the transaction parameter record was created, and current time minus delta. A delta is defined as a discrete amount of time from when the authorization was given and the time the subsequent submission. If delta is greater than a predefined period, then the record will not be identified as a prior submission. Otherwise, if the record includes authorization from all required ACHs (180), and delta is less than the predefined period, then the process proceeds to approve the transaction (step 895). If, however, no previous authorization has been provided, the ATA treats the authorization request as a new transaction and declines the transaction (step 890).

Upon declining a transaction, the ATA queries all ACHs (180) associated with the card used for the transaction, via text message, sent through an SMS aggregator's application programming interface (“API”) (step 820). SMS aggregators may also provide encryption services for further security. The query may, but is not limited to, include a unique keyword which ACHs must respond with to approve a subsequent submission. The query may also include, but is in no way limited to the parameters of the denied transaction, e.g. merchant (120) ID or name, total transaction price, card number, card holder name, date and time of transaction, and location.

The query in step 820 is stored as a transaction record in ATA's (170) electronic storage device and cache (step 830). Query parameters, and other parameters not listed may be stored as well.

When a response to the query is received from the ACH (step 840), via SMS aggregator API, the ATA (170) then determines if the response is an authorization or an indication of a desire to decline (step 850). If ATA (170) receives authorization (Yes, step 850), the corresponding transaction record is retrieved. Authorization from ACH is stored in the transaction record and notification of the ACH (180) approval is sent via the SMS aggregator (330) to purchaser (110) and other associated ACHs (180). If sufficient ACHs have granted approval then notification of approval is sent to purchaser (110) and all associated ACHs (180) to the transaction.

Conversely, if sufficient ACH replies are not received (No, step 850), the transaction is declined (step 890) and notification of such is sent to the ACHs (180) and purchaser (step 860). According to one exemplary embodiment, any time a transaction is declined, the declined submission may be routed to CIB (160) or any other source interfacing with the ATA.

When a transaction is approved by the ATA (step 895), the transaction is routed to the CIB (160), and the cached record may be deleted or marked as final, to prevent further transactions with similar parameters being approved. Approval may also be routed to any source interfacing with the ATA, e.g., CCN (150).

### III. NFC Applications

Another ATA-related process involves the use of near field communication (NFC) technology. Various NFC devices (e.g., chips, receivers, and transmitters) may be used by the purchaser and merchant to communicate information and facilitate a transaction. The use of NFC technology may make it possible to communicate between the purchaser's handheld device (e.g., smart phone) and the ATA rather than communications with the ATA being limited to the merchant. In some embodiments, the merchant may have NFC technology as part of a point of sale device, and the purchaser's handheld device may also include NFC technology to provide communication directly when the merchant and purchaser devices are in close proximity. In other embodiments, the merchant and purchaser NFC devices may communicate via the web (e.g., Internet), a carrier network, a proprietary messaging and communication network, or the ATA. Similarly, while the present exemplary system is described as using NFC technology, and number of wireless communication protocols and systems may be implemented according to the present systems and methods including, but in no way limited to, blue tooth, blue tooth low energy systems, and radio frequency (RF) systems.

NFC is a short-range, high frequency wireless communication technology that enables the exchange of data between devices over a distance of about 4-12 inches (10-30 cm). The technology is a simple extension of the ISO/IEC 14443 proximity-card standard (proximity card, RFID) that combines the interface of a smartcard and a reader into a single device. An NFC device can communicate with existing ISO/IEC 14443 smartcards and readers, as well as with other NFC devices, and is thereby compatible with existing contactless infrastructure already in use for various payments infrastructure. NFC is primarily aimed at usage in mobile phones.

Similar to ISO/IEC 14443, NFC communicates via magnetic field induction, wherein two loop antennas are located within each other's near field, effectively forming an air-core transformer. NFC operates within the globally available and unlicensed radio frequency ISM band of about 13.56 MHz. Most of the RF energy is concentrated in the typical 14 kHz bandwidth range, but the full spectral envelope may be as wide as about 1.8 MHz when using amplitude shift keying (ASK) modulation.

NFC includes a passive communication mode in which an initiator device provides a carrier field and a target device answers by modulating the existing field. In this mode, the target device may draw its operating power from an initiator-provided electromagnetic field, thus making the target device a transponder. NFC also includes an active communication mode wherein both initiator and target devices communicate by alternately generating their own fields. A device deactivates its RF field while it is waiting for data. In this mode, both devices typically have power supplies.

NFC typically employs two different codings to transfer data. If an active device transfers data at about 106 kbit/s, a modified Miller coding with approximately 100% modulation is used. In all other cases Manchester coding is used with a modulation ratio of about 10%. NFC devices are able to receive and transmit data at the same time. Thus, NFC devices need to check the radio frequency field and can detect a collision if the received signal does not match with the transmitted signal.

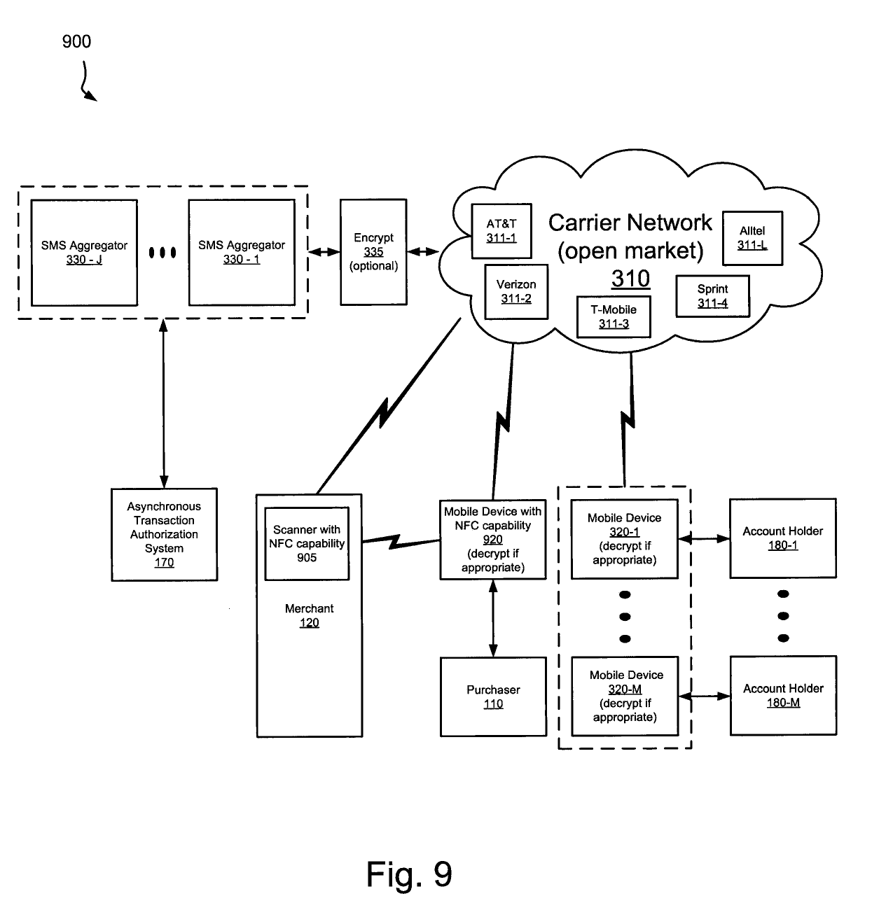

FIGS. 9-14 illustrate several ATA embodiments and related systems and methods that implement aspects of NFC technology in association with the asynchronous mobile authorization systems disclosed herein. Referring first to FIG. 9, a cellular communication system (900) is shown including many of the same or similar features as included in the cellular communication system (300) described above. The system (900) may include a scanner with NFC capability (905) associated with the merchant (120). A mobile device with NFC capability (920) is associated with the purchaser (110). The NFC devices of the purchaser's mobile device (920) and the merchant's scanner (905) communicate while in close proximity (e.g., 4-12 inch range). The mobile device (920) and NFC features associated with the merchant (120) may communicate individually with the ATA system (170) via, for example, the carrier network (310), SMS aggregator (330) and optional encryption (335).

Other communication technologies, such as those discussed above with reference to, for example, FIGS. 1-8 may also be used. For example, any of the MMS and SMTP technologies and related aggregators may be used. Other networks and systems such as the proprietary messaging and communication network of FIG. 4 and the Internet may be used to provided the desired communication paths.

The mobile device (920) and scanner (905) may include NFC capability, or at least one of these may be functional without NFC capability. In one example, providing the mobile device (920) with an NFC capability may provide the ability to have the purchaser's mobile device be capable of contacting and interfacing with the ATA system (170) rather than the merchant's device. In at least one example, the mobile device (920) may interface and communicate with the scanner (905) to collect information about the desired transaction such as, for example, information about the merchant, product information, and a purchase price, and that information is communicated to the ATA system (170) via the mobile device (920) for pre-authorization. The required authorization obtained via the ATA system (170) may be communicated back through the mobile device (920) and even, in various embodiments, to the merchant (120) via the scanner (905) in order to complete the transaction.

In other examples, both the merchant device and purchaser device may communicate with the ATA system (170). In still further examples, the purchaser (110) may provide the needed authorization and communication of payment information (e.g., a credit card number) via the mobile device (920) to complete the transaction with the merchant (120) without the ATA system (170) obtaining a separate authorization related to the transaction. The NFC capabilities available on at least one of the mobile device (920) and scanner (905) may be used in combination with other verification or authorization information (e.g., a password, code or other unique identifier) that the purchaser (110) can provide locally without independent authorization collected by the ATA system (170).

In some examples, the ATA system (170) may include a pre-authorization of aspects of an imminent transaction being conducted by the purchaser (110), and at least one of the merchant (120) and purchaser (110) obtains access to the pre-authorization information held by the ATA system (170) in order to obtain authorization or denial for the imminent transaction. The above description related to FIGS. 1-8 provide examples of such pre-authorization, which may be integrated with NFC technologies according to further embodiments.

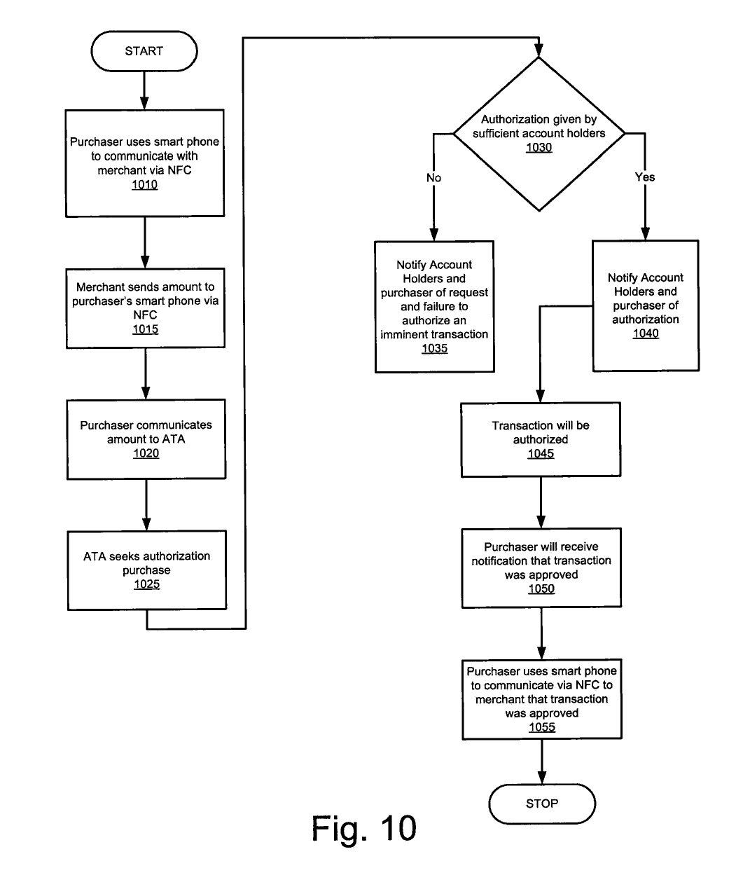

FIGS. 10-14 illustrate exemplary steps according to various embodiments as described in further detail below. Other embodiments may selectively omit, add to, reorder, and/or modify the steps shown and described with reference to FIGS. 10-14.

Referring now to FIG. 10, an example process for authorizing a transaction using the ATA system is shown according to one exemplary embodiment. As shown in FIG. 10, when a purchaser (110) has identified a desired transaction that he wishes to complete, the purchaser uses a smart phone or other mobile communication device to communicate with the merchant (120) via a near field communication device (e.g., chip) (step 1010). The NFC device may be carried by the purchaser's mobile device, the merchant's point of sale device, or both. The NFC device may be used to initiate the transaction, such as prompt a responsive communication from the merchant's point of sale device such as providing a purchase price.

The merchant sends a purchase price or amount to the customer's mobile device via an NFC communication (step 1015). The purchaser communicates the purchase price to the ATA (170) (step 1020). The ATA seeks authorization for the purchase (step 1025). Authorization for the purchase may include, for example, using any one of the methods shown in FIGS. 6 and 7 described above.

Authorization for the transaction may be given via the ATA by the purchaser for an account and/or account holders (step 1030). If authorization is not given, the account holders and purchaser are notified of the request, success, or failure to authorize an imminent transaction (step 1035). If the authorization is given, the account holders and purchasers are notified of the authorization (step 1040). The transaction will be authorized (step 1045) and the purchaser will receive notification that the transaction was approved (step 1050). The purchaser uses the mobile communication device to communicate via, for example, NFC technology, to the merchant that the transaction was approved (step 1055). The transaction may then be completed via the NFC technology or using traditional credit card based systems.

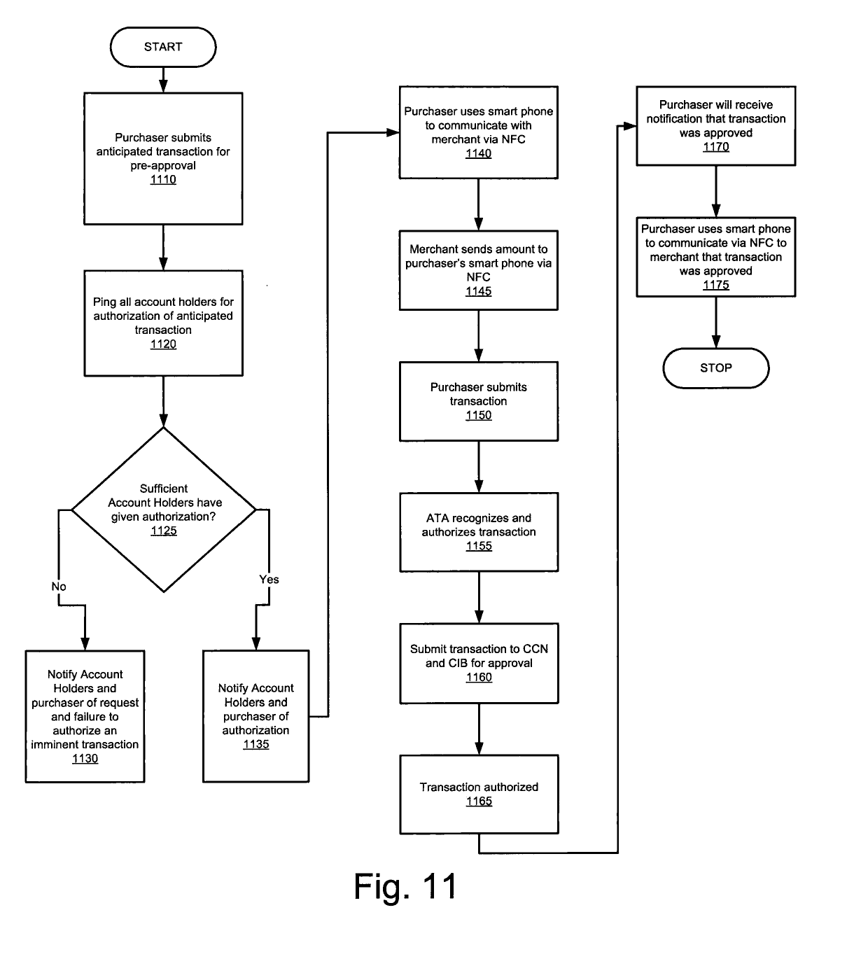

Referring to FIG. 11, another example process for completing a transaction using the ATA system is shown according to one exemplary embodiment. In an initial step, the purchaser submits an anticipated transaction for preapproval (step 1110). The ATA system (170) requests authorization from all account holders for the anticipated transaction (step 1120). The ATA system (170) queries whether sufficient account holders have given authorization (step 1125). If sufficient authorization is not given, the account holders and purchaser are notified of their request and failure to authorize an imminent transaction (step 1130). If sufficient authorization is given, the account holders and purchaser are notified of the authorization (step 1135).

The purchaser uses a mobile device (e.g., smart phone) to communicate with the merchant via NFC technology (step 1140). The merchant sends the purchase amount, transaction number, and other information to the customer's smart phone via NFC technology (step 1145). The NFC communication may occur using an NFC device carried by one or both of the purchaser's smart phone (e.g., mobile device) and the merchant's point of sale device (e.g., scanner). According to one exemplary embodiment, the purchaser device submits the transaction to the ATA system (170) (step 1150). The ATA system authorizes the transaction based at least in part on the pre-authorization that has occurred in earlier steps (step 1155). The transaction is then submitted to CCN and CIB for approval (step 1160) and the transaction is authorized (step 1165).

The purchaser will receive notification that the transaction was approved (step 1170). The purchaser then uses the smart phone to communicate via NFC technology to the merchant that the transaction was approved (step 1175) including authorization and verification codes. Alternatively, the notice of transaction authorization may be sent directly to the merchant and NFC technology may be used to communicate the transaction authorization, confirmation, and receipt from the merchant to the purchaser. In still further embodiments, the transaction authorization notice may be sent to both the purchaser and the merchant, and the merchant uses the approval to complete the transaction.

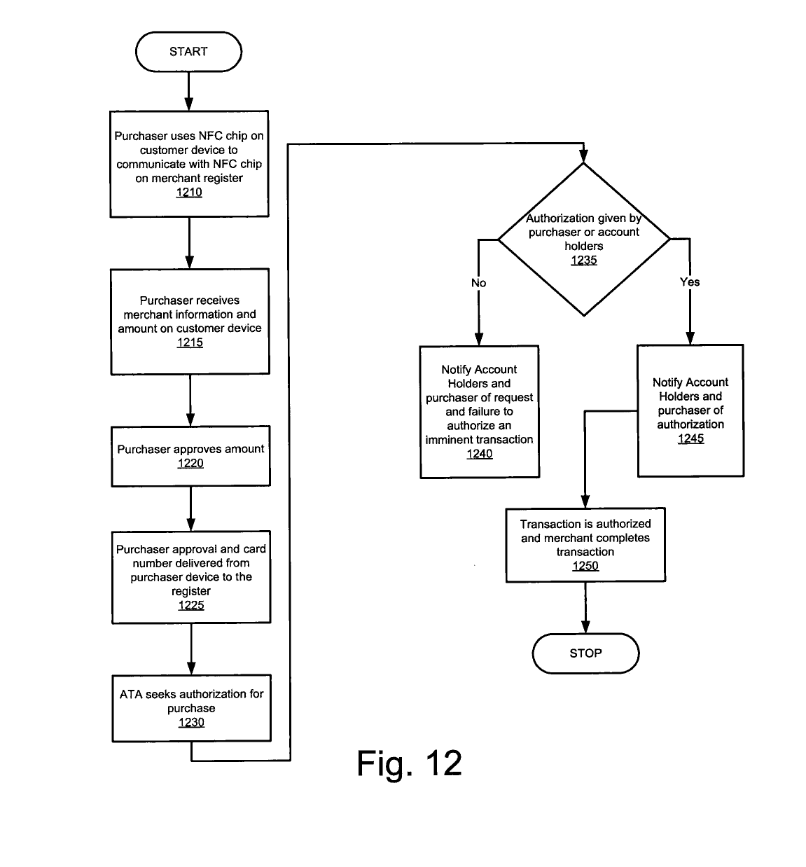

FIG. 12 illustrates another example process for completing a transaction using the ATA system (170) according to another exemplary embodiment. In an initial step the purchaser uses an NFC chip (or other NFC or wireless technology) included on the purchaser's mobile device (e.g., smart phone) to communicate with an NFC chip (or other NFC or wireless technology) on the merchant's register or other point of sale device (step 1210). The purchaser receives merchant information and purchase amount on the purchaser's mobile device sent via the NFC chip (step 1215). The purchaser approves the amount (step 1220). The approval may occur using, for example, a key word, code, signature, voice activation, or other means of security authorization.

The purchaser approval and credit card number or other payment information may be delivered from the purchaser's mobile device to the merchant's register via the NFC chip, the Internet, a carrier network or other wireless medium (step 1225). The ATA system (170) receives the transaction information as described above, and seeks authorization for the purchase (step 1230). Authorization is sought from the account holders (step 1235) as described above. If the proper authorization is not provided, a notification is sent to the account holders and purchaser related to the request and failure to authorize an imminent transaction (step 1240). If the proper authorization is received, the account holders and purchaser are notified of the authorization (step 1245). The transaction is authorized and the merchant completes the transaction (step 1250) using the received information.

In accordance with this example, the NFC technology permits wireless communication between the purchaser's mobile device and the merchant's point of sale device (e.g., register). Implementation of the ATA system (170) in conjunction with the NFC capable purchaser mobile device may provide an increased level of security and protection for the purchaser's account information that is being communication via the Internet, carrier network, or other communication medium, or directly between the purchaser's mobile device and the merchant's point of sale device using the NFC technology.

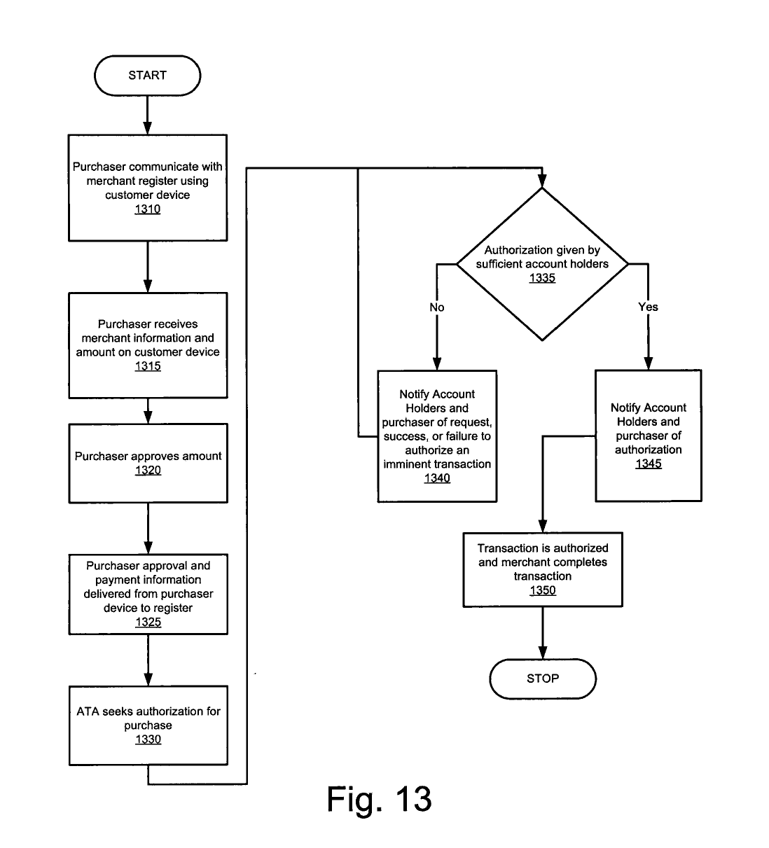

FIG. 13 illustrates another example exemplary process for conducting a transaction using the ATA system (170) in accordance with one exemplary embodiment. In this embodiment, a purchaser initiates the process by communicating with a merchant register or other point of sale device using a customer device (e.g., a mobile communication device such as a cell phone) (step 1310). The customer receives merchant information and purchase amount on the customer device (step 1315). The communication between the purchaser device and the merchant register may occur using NFC technology or another wireless technology. The NFC technology may manually or automatically initiate communication.

The purchaser approves the purchase amount received from the merchant register (step 1320). The purchaser approval and payment information may be delivered from the purchaser device to the register (step 1325). The ATA seeks authorization for the purchase as described previously (step 1330).

Authorization is given by the purchaser or account holders (step 1335). If proper authorization is not given, the account holders and purchaser are notified of the request and failure to authorize an imminent transaction (step 1340). If proper authorization is given, the account holders and purchaser are notified of the authorization (step 1345). The transaction is authorized and the merchant completes the transaction (step 1350). The merchant may be informed about the authorization via, for example, a communication by the purchaser's device to the merchant's register, or communication directly from the ATA system to the merchant. In one example, communication between the purchaser device and the merchant register or other point of sale device may occur using, for example, NFC technology.

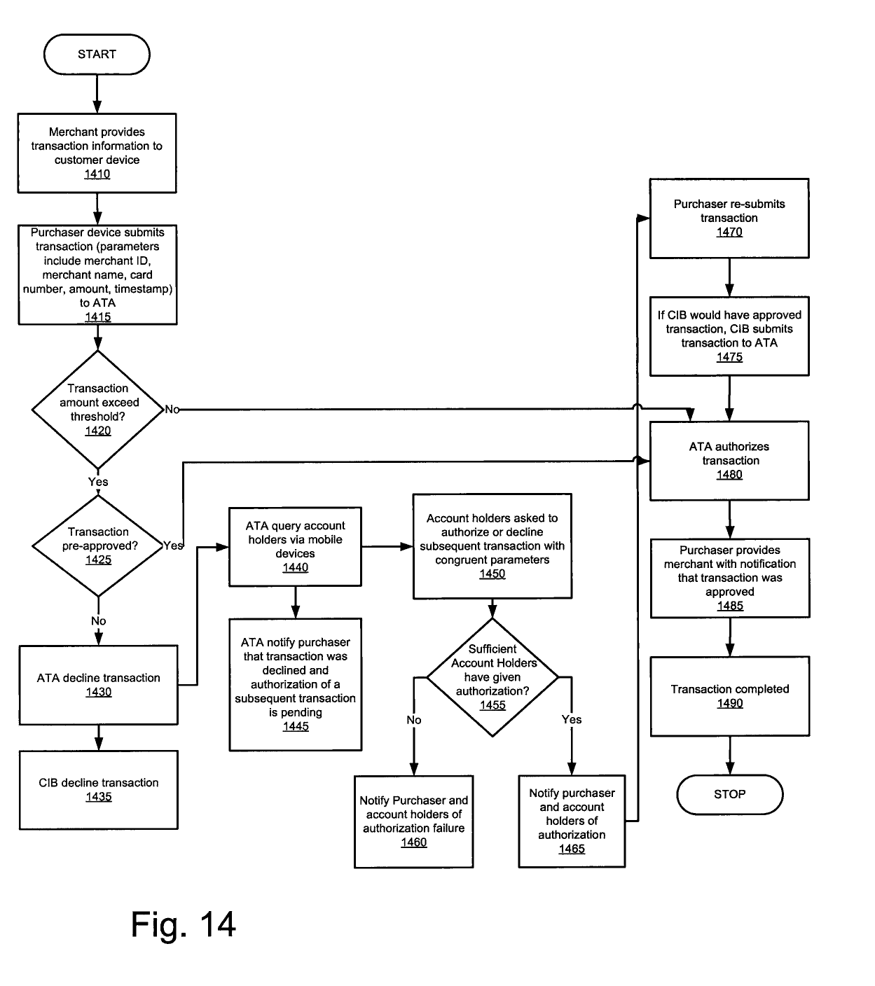

FIG. 14 illustrates another example process of conducting a transaction using the ATA system (170). The method shown in FIG. 14 is initiated with a merchant providing transaction information to a purchaser device (e.g., a mobile device such as a smart phone) (step 1410). The purchaser device submits transaction information (e.g., parameters including, for example, merchant id, merchant name, card number, account, purchase amount, and time stamp) directly to the ATA system (170) (step 1415). The ATA system inquires whether the transaction amount exceeds a threshold amount (step 1420). If the transaction amount is not exceeded, the ATA system authorizes the transaction (step 1480). If the transaction amount is exceeded, the ATA system inquires whether the transaction is preapproved (step 1425). If the transaction is preapproved, the ATA system authorizes the transaction (step 1480). If the transaction is not preapproved, the ATA system declines the transaction (step 1430) and the CIB declines the transaction (step 1435). While this declination is formalistic, it serves as a fraud prevention measure should the credit card transaction information be compromised. The ATA system then queries the account holders via mobile devices (step 1440) for authorization. The ATA system (170) notifies the purchaser that the transaction was declined and that authorization of the subsequent transaction is pending (step 1445). Currently, the account holders are asked to authorize or decline the subsequent transaction with congruent parameters (step 1450).

If sufficient account holders have given authorization (step 1455), the purchaser and account holders are notified of the authorization (step 1465). If the proper authorization is not obtained, the purchaser and account holders are notified of the authorization failure (step 1460). After authorization is obtained, the purchaser resubmits the transaction (step 1470). If the CIB would have approved the transaction, the CIB submits transaction to the ATA system (step 1475). The ATA system authorizes the transaction (step 1480), and the purchaser provides the merchant with notification that the transaction was approved (step 1485). The transaction is then completed (step 1490).

Communication of information between the merchant and the purchaser device may occur using many different technologies and communication mediums. For example, the NFC technology disclosed here may be used to communicate information about the transaction and authorization for the transaction between the purchaser device and the merchant point of sale device. Authorization for the transaction may come from the ATA system directly to the merchant or to the purchaser device, and either the merchant device or the purchaser device may communicate that authorization to the other via, for example, the NFC technology.

The various methods described with reference to FIGS. 10-14 provide some examples of how NFC technology may be used at the point of sale to communicate information such as authorization for the transaction between the purchaser and the merchant. The NFC technology may also help in communications with the ATA system. The ATA system may provide a structure for approval or preapproval of at least one card holder associated with the NFC device (e.g., chip) associated with the purchaser's mobile device (e.g., smart phone). The communication of authorization and payment account information (e.g., a credit card number) may be controlled with the ATA to avoid improper use of the account information (e.g. credit card number).

Other applications included on purchaser mobile communication devices (e.g., smart phones) may be compatible with the functionality of the ATA system. In one example, the customer may physically tap or connect their mobile communication device to the merchant point of sale device (e.g., the bump application for iPhones) or use a bar code or other pattern that can be used to communicate with the merchant. This communication may include, for example, initiation of a transaction request, communication of the transaction data, communication of authorization for the transaction, and payment information such as, for example, a credit card number. Communication of payment information such as a credit card number or bank account number may be controlled with the ATA system and given only after proper authorization by the account holder, the purchaser, or a combination of the account holder and purchaser or a number of other required authorization sources.

In some arrangements, the credit card information being accessed for a purchaser's transaction may be stored remotely from the purchaser's mobile device. The credit card information may be accessible via, for example, the ATA (170), the Internet, or other database. The NFC device carried by the purchaser's phone may be associated with the credit card information so that initiation of a transaction using the purchaser's mobile device involves a step of linking the credit card information to the transaction. The credit card information may be accessible only after authorization for the transaction managed by, for example, the purchaser using the mobile device, the ATA (170), or some other authorization device or system. In other embodiments, the credit card information is stored directly on the purchaser's mobile device to provide easier access to the credit card information during the transaction.

### IV. Alternative Embodiments

In addition to the above-mentioned systems and methods, a number of alternative embodiments may be incorporated. According to one alternative embodiment, the present system and method may not be limited to a single transaction. More particularly, the ATA can track the total spending by a purchaser associated with a credit card for a predetermined period of time. According to this exemplary embodiment, the ATA will continue to pass purchases through to the CCN and CIB for normal processing, so long as the predetermined threshold is not exceeded. However, when the predetermined threshold is exceeded for the identified period of time, the ATA will be activated and sufficient approval from the ACH will be required for subsequent authorizations during the designated time periods. It will be understood that, according to this exemplary embodiment, any time period may be designated including, but in no way limited to, a number of hours, days, weeks, months and/or years.

Additionally, according to one exemplary embodiment, pre-authorization may be obtained. According to this embodiment, a module on a handheld device may include instructions which, when accessed by a processor of the handheld device, enable the processor to receive images of bar-codes, interpret the bar-codes and correlate the bar-codes with a product and price, and calculate the transaction cost of purchasing the one or more items associated with the bar-code(s). The exemplary module may incorporate known bar-code and product correlation systems and methods commercially available, such as utilized in the RedLaser Iphone app by Occipital and other similar products. According to this alternative embodiment, when a purchaser has identified all the products they will be purchasing, the computer readable instructions can cause the processor to submit the anticipated charges to the ATA system (170) as an initial transaction exceeding the predetermined threshold amount so that authorization from sufficient ACHs (180) may be obtained.

Yet another exemplary embodiment of the present system and method may further reduce and/or eliminate the possibility of identify theft and fraud by incorporating security features in addition to the numerous features detailed above. For example, according to one exemplary embodiment, the above-mentioned systems and methods, may include, but are in no way limited to, at least a two part authorization process.

While the present exemplary system and method includes transmitting messages and authorizations wirelessly, it may be possible for a technically savvy criminal to assume an ACH's caller ID or hack into someone's network to assume their identification credentials. However, it is quite technologically difficult to intercept an SMS message directly to your phone, in order to perpetrate a fraud.

According to this exemplary embodiment, the ATA may request additional verification and/or confirmation after the initial pre-purchase authorization and confirmation was given, as detailed above. The confirmation message may include, but is in no ways limited to, the parameters of the anticipated or declined transaction, a note from the purchaser, a time period for which a code will be active, and a specific code that the ACH must copy and paste in a response to the ATA.

Specifically, according to one exemplary embodiment, the customer or ACH may send, via SMS, a request for pre-approval. In response, when the request has been granted, as described in detail above, the ATA sends confirmation including a code. When received, the customer cuts and pastes code into a second confirmation reply and sends the message (including the code) to the ATA. Upon receipt, the ATA confirms that the correct code has been received and sends a subsequent message detailing that x amount will be approved for the next y minutes. In sum, the exemplary system including enhanced fraud protection includes the sending of two SMS messages: one to initiate and provide pre-authorization, and a second to confirm the details sent back to them by the ATA system. Response to the second approval may be in any of the forms mentioned above, including, but in no way limited to, the transmission of a Y or a N, the selection of a GUI interface meant to simulate a physical button, the entry of a code in the response, and the like.

An additional method that may be used independently or in combination with the double authentication method detailed above includes providing a predefined personal identification number (“PIN”) to each ACH. In this exemplary embodiment, the ACH (180) may previously receive or independently set a PIN, such that when an ACH (180) replies to a query for authorization, the ATA (170) will only accept authorization if the PIN associated with the transmitting ACH is included. An ACH (180) may also include the PIN in the original authorization. In order to circumvent this exemplary theft prevention, a thief must have the ACH's card and PIN, while spoofing the ACH's phone number. If the use of a PIN is implemented with the exemplary double authorization method, a thief would need the ACH's card, PIN, and phone to make any fraudulent charges.

Yet another exemplary embodiment, may include, but is in no way limited to, public/private key encryption. This could be implemented using the SMS (300) or PMCN (400). When the bank account is setup to use the ATA a private and public key is generated and placed on the respective devices and systems. Thereafter the query will only be readable by someone using a specific phone, and the response will also only be readable by the ATA.

The preceding exemplary views of the ATA may be implemented as either pre- or post-transaction methods.

In the preceding exemplary views the ATA system includes authorizations by one or more ACHs (180), this may include, but is in no way limited to, situations where there are multiple ACHs and those ACHs are the parents of the purchaser (110), or a company where the ACHs (180) are officers or supervisors within that company and an employee is the purchaser (110). By requiring a certain level of authorization for purchases exceeding a predefined amount, the present exemplary system reinforces fiscal responsibility while providing account security and fraud protection.

Traditional transactional systems and methods have relied solely on possession of the credit card or credit card information to authorize transactions. However, such security measures have been proven to be unreliable, and do not provide the flexibility that families, groups, or companies may enjoy with the exemplary systems described or similar systems. The present exemplary system and method ensures that, despite the theft of a credit card or credit card information, the merchant (120), the ACHs (180) and purchasers (110) are protected from unauthorized charges. Furthermore, this method would not impose an unforeseen or unreasonable burden on merchants (120) or cause embarrassment for the purchaser (110) as they are accustomed to denial of an initial transaction, with the approval of a subsequent submission. Lastly the notifications transmitted to the purchaser (110) and ACHs (180) described in the exemplary system would allow the purchaser (110) to know and update the merchant (120) of the authorization progress of the intended transaction.

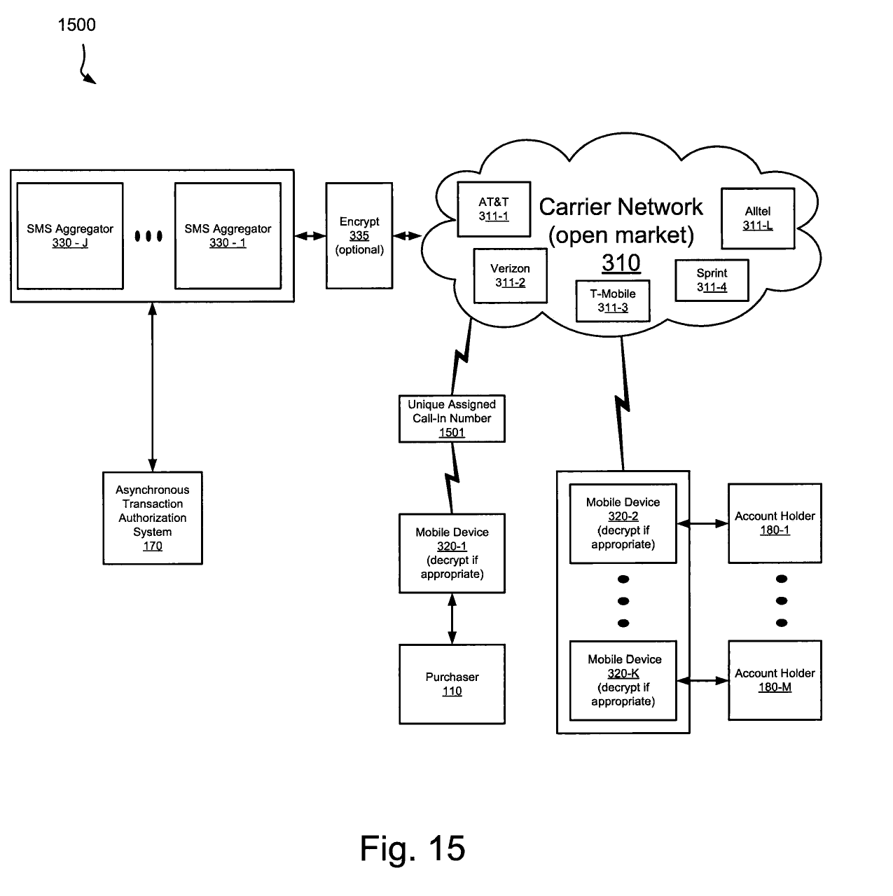

Another exemplary embodiment may include additional security measures related to communications between the purchaser (110) and the ATA (170). Referring to FIG. 15, a cellular communication system (1500) is shown including many of the same or similar features as included in the cellular communication systems (300), (900) described above. Additionally, the system (1500) may provide communication between the mobile devices (320), (920) and the ATA (170) (via, for example, the Carrier Network (310)) using a unique assigned call-in number (1501).

The ATA (170) may use multiple (e.g., thousands) of unique phone numbers to receive customer transaction requests via, for example, SMS from the mobile devices (320), (920). A single call-in number (1501) may be assigned to or selected by or for each customer. Typically, the customer would be the only person that has access to that call-in number (1501) outside of the ATA (170). The call-in number (1501) is preferably used solely for communicating transaction requests from the mobile devices (320), (920) to the ATA (170), in contrast to other information (e.g., credit card numbers, billing address, CVV code, mobile phone number, etc.) from the customer that may be distributed for other purposes besides the requested transaction and accessible for fraudulent purposes. The call-in number (1501) may be stored by the ATA (170).

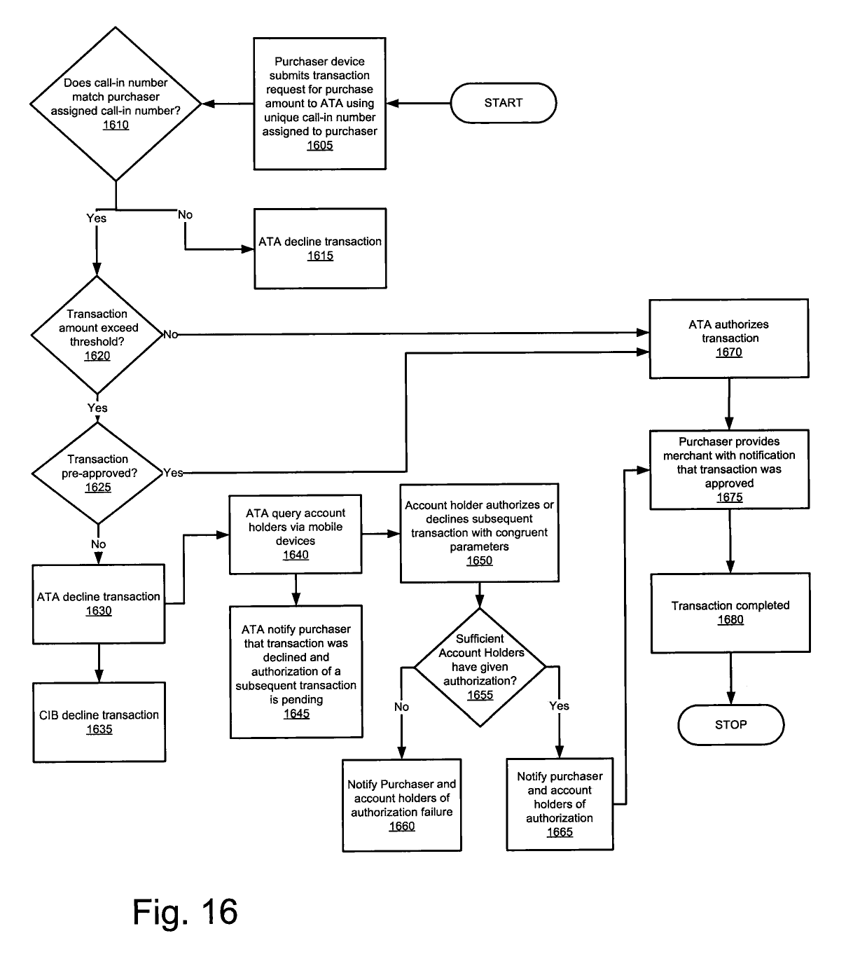

FIG. 16 illustrates another example process of conducting a transaction using the ATA (170). The method shown in FIG. 16 is initiated with a purchaser device submitting a transaction request for purchase amount to the ATA using a unique call-in number (1501) assigned to the purchaser (step 1605). The ATA inquires whether the call-in number matches a purchaser assigned call-in number on file (step 1610). If the call-in number does not match the assigned call-in number, the ATA declines the transaction request (step 1615). If the call-in number matches the assigned call-in number, the ATA then inquires whether the transaction amount exceeds a threshold (step 1620). If the transaction amount is less than the threshold, the ATA authorizes the transaction (e.g., via SMS) (step 1670). If the transaction amount is greater than the threshold, the ATA inquires whether the transaction is preapproved (step 1625). If the transaction is preapproved, the ATA authorizes the transaction (step 1670). If the transaction is not preapproved, the ATA declines the transaction (step 1630). A CIB may then decline the transaction (step 1635).

The ATA then queries the account holders via mobile devices (step 1640) for authorization. The ATA notifies the purchaser that the transaction was declined and that authorization of the subsequent transaction is pending (step 1645). The account holders authorize or decline the subsequent transaction with congruent parameters (step 1650). If sufficient account holders have given authorization (step 1655), the purchaser and account holders are notified of the authorization (step 1665). If the proper authorization is not obtained, the purchaser and account holders are notified of the authorization failure (step 1660). If the authorization is obtained, the purchaser and account holders may be notified of the authorization (step 1665). The ATA system authorizes the transaction (step 1670), and the purchaser provides the merchant with notification that the transaction was approved (step 1685). The transaction is then completed (step 1680).

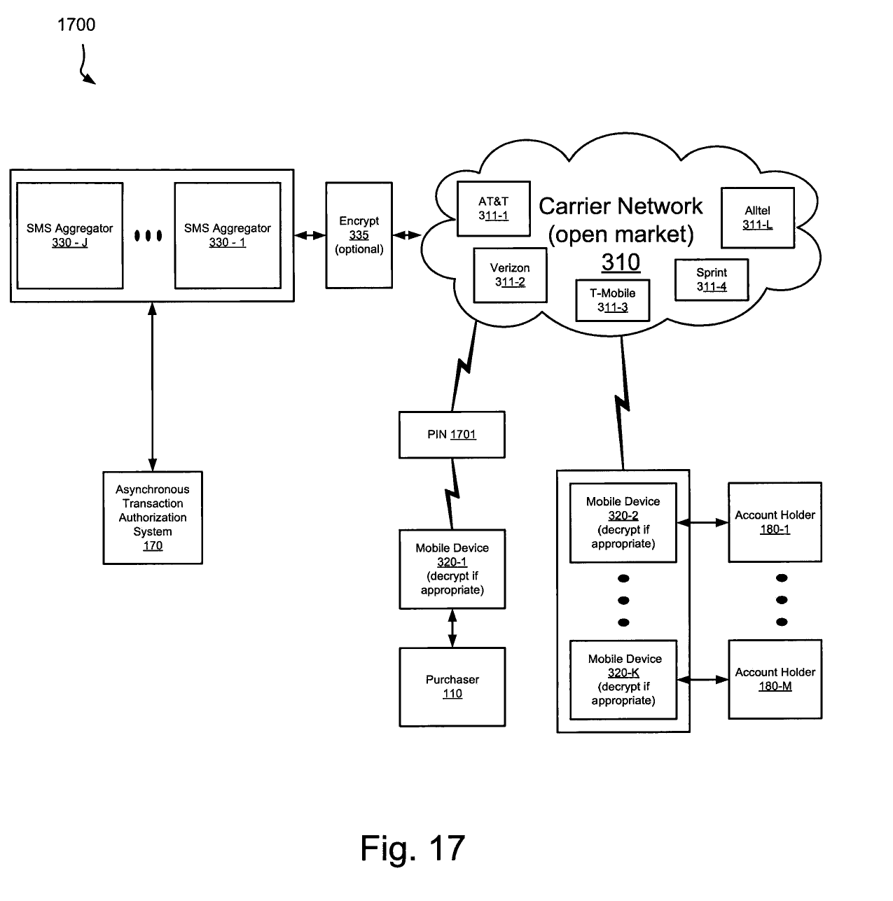

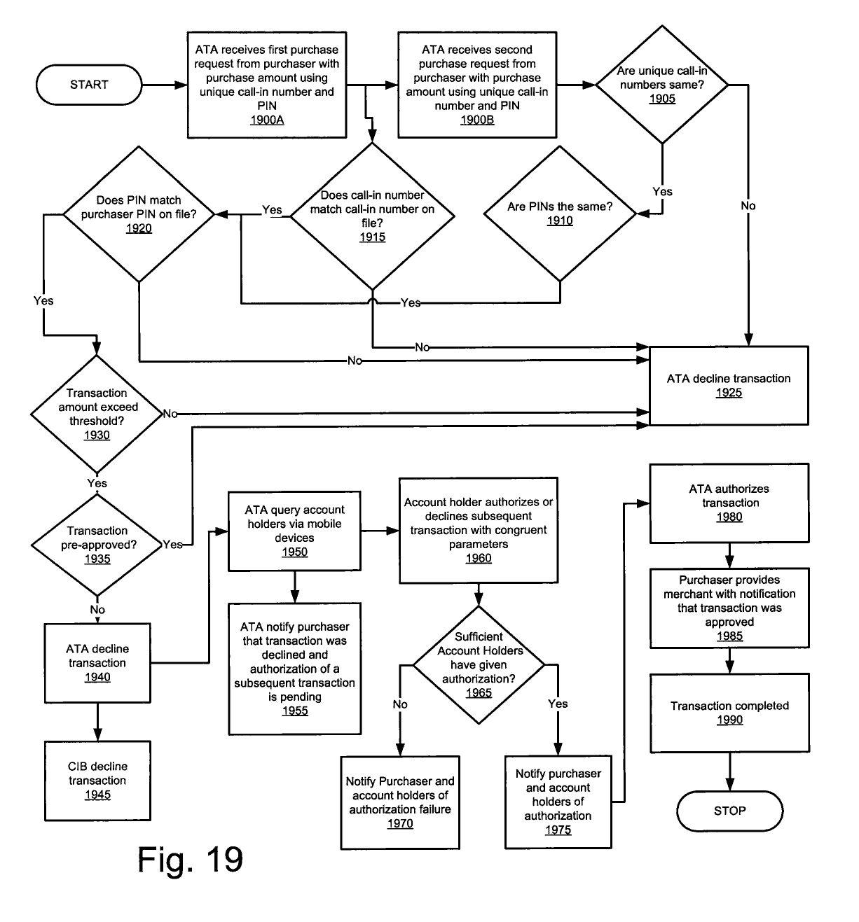

Another exemplary embodiment may include the use of a personal identification number (PIN) as a security measure in communications between the purchaser (110) and the ATA (170). Referring to FIG. 17, a cellular communication system (1700) is shown including many of the same or similar features as included in the cellular communication systems (300), (900), (1500) described above. Additionally, the system (1500) may implement use of a PIN (1701) in communications between the mobile devices (320), (920) and the ATA (170) (via, for example, the Carrier Network (310)). The PIN (1701) may be used separate from the call-in number (1501) described with reference to system (1500). In other arrangements, the PIN (1701) may be communicated to the ATA using the call-in number (1501) (see description below with reference to FIG. 19).

A single PIN (1701) may be assigned to each customer. Typically, the customer would be the only person that has access to that PIN (1701) outside of the ATA (170). The PIN (1701) is preferably used solely for communicating transaction requests from the mobile devices (320), (920) to the ATA (170), in contrast to other information (e.g., credit card numbers, billing address, CVV code, mobile phone number, etc.) from the customer that may be distributed for other purposes besides the requested transaction and accessible for fraudulent purposes.

The PIN (1701) may have any desired configuration, sequence, or combination. For example, the PIN (1701) may be a number (e.g., four digit number), may be a combination of numbers and non-numerical symbols (e.g., letters, etc.), or may be non-numerical. The PIN (1701) may be selected by the customer, or may be randomly selected and assigned by the ATA (170). The PIN (1701) may be stored by the ATA (170).

The PIN (1701) may be communicated to the ATA in a single communication with the transaction request (e.g., along with a purchase amount in an SMS). For example, a customer may send a transaction request in the form of an SMS that includes a purchase price (e.g., $187.15) and the PIN (1701) (e.g., 3498). The purchase price and PIN (1701) may be separated by a comma in a line of the SMS, or may be included on separate lines in the SMS. In other embodiments, the PIN (1701) may be sent in a separate communication (e.g., SMS) from the transaction request.

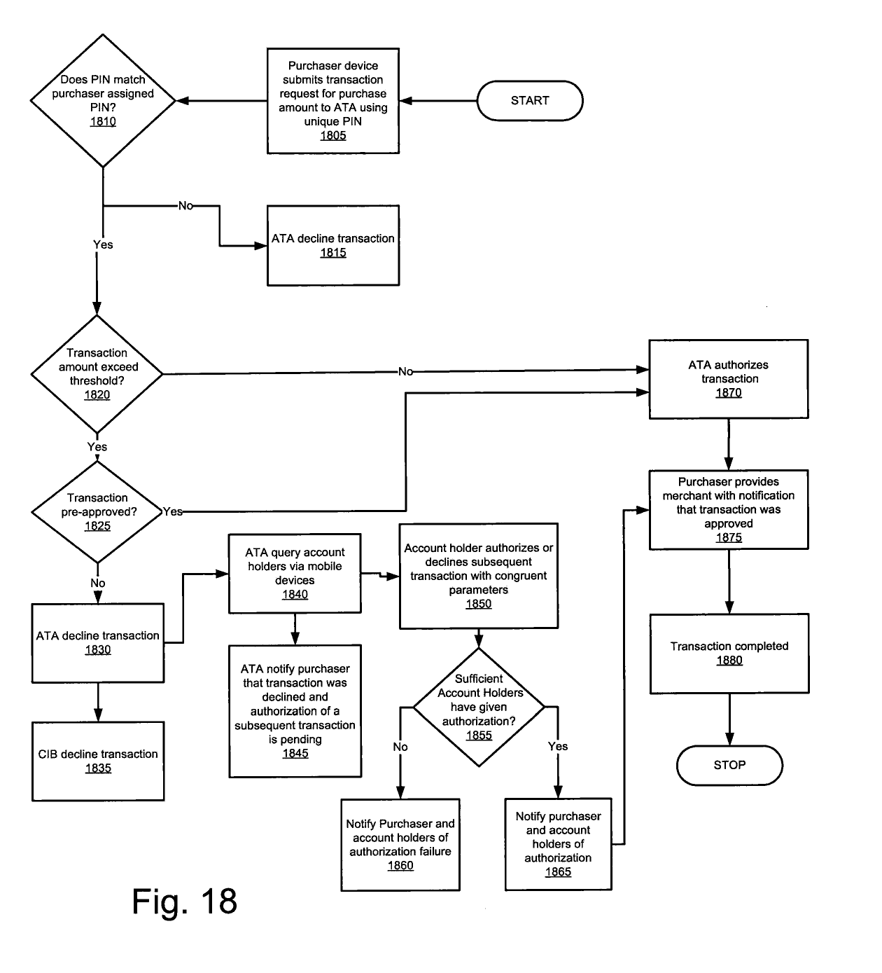

FIG. 18 illustrates another example process of conducting a transaction using the ATA (170). The method shown in FIG. 18 is initiated with a purchaser device submitting a transaction request for purchase amount to the ATA using a unique PIN (1701) (step 1805). The ATA inquires whether the PIN matches a PIN on file for the customer (step 1810). If the PIN does not match the stored PIN, the ATA declines the transaction request (step 1815). If the PIN matches the stored PIN, the ATA then inquires whether the transaction amount exceeds a threshold (step 1820). If the transaction amount is less than the threshold, the ATA authorizes the transaction (e.g., via SMS) (step 1870). If the transaction amount is greater than the threshold, the ATA inquires whether the transaction is preapproved (step 1825). If the transaction is preapproved, the ATA authorizes the transaction (step 1870). If the transaction is not preapproved, the ATA declines the transaction (step 1830). A CIB may then decline the transaction (step 1835).

The ATA then queries the account holders via mobile devices (step 1840) for authorization. The ATA notifies the purchaser that the transaction was declined and that authorization of the subsequent transaction is pending (step 1845). The account holders authorize or decline the subsequent transaction with congruent parameters (step 1850). If sufficient account holders have given authorization (step 1855), the purchaser and account holders are notified of the authorization (step 1865). If the proper authorization is not obtained, the purchaser and account holders are notified of the authorization failure (step 1860). The ATA system authorizes the transaction (step 1870), and the purchaser provides the merchant with notification that the transaction was approved (step 1875). The transaction is then completed (step 1880).

Another exemplary embodiment includes the use of both a PIN (1701) and a unique call-in number (1501) as security measures in communications between the purchaser (110) and the ATA (170). FIG. 19 illustrates another example process of conducting a transaction using the ATA (170). A transaction request according to the example of FIG. 19 may be declined based on either an incorrect or repeated use of a unique call-in number, or the use of an incorrect PIN. One advantage of the method of FIG. 19 is identification of potential phishing activity. If the ATA (170) receives multiple transaction requests coming from a single customer mobile device (or a cellular number of one of the customer's mobile devices) that are being sent to two or more unique call-in numbers, the phishing attempt can be identified and the customer's account shut down. Even if a possible unauthorized user had in his possession all of the unique call-in numbers for the ATA (170), the unauthorized user could not start trying each of the call-in numbers to get an approval without being identified.

The method shown in FIG. 19 is initiated with the ATA (170) receiving a first purchase request from a purchaser (or the purchaser's cellular number) using a unique call-in number, a PIN and a purchase amount (step 1900A). The ATA inquires whether the call-in number matches a call-in number for the purchaser that is on file (step 1915). If the call-in number is not correct, the ATA may decline the transaction (step 1925). If the call-in number is correct, the ATA inquires whether the PIN matches a purchaser's PIN on file (step (1920). If the PIN is incorrect, the ATA may decline the transaction (step 1925).

In some situations, a second purchase request may be received by the ATA from the purchaser with a unique call-in number, a PIN and a purchase amount (1900B). When such second (or more) purchase requests are received, the ATA inquires whether the call-in numbers of the first and second purchase requests are the same (step 1905). If the call-in numbers are not the same, the ATA may decline the transaction (step 1925). If the call-in numbers are the same, the ATA inquires whether the PINs are the same (step 1910). If the PINs are not the same, the ATA may decline the transaction (step 1925). If the PINs are the same, the ATA inquires whether the PIN matches a purchaser PIN on file (step 1920). The order of the inquiries by the ATA (170) concerning call-in numbers and PINs may be switches in other embodiments.

If the PIN matches the stored PIN, the ATA then inquires whether the transaction amount exceeds a threshold (step 1930). If the transaction amount is less than the threshold, the ATA authorizes the transaction (e.g., via SMS) (step 1980). If the transaction amount is greater than the threshold, the ATA inquires whether the transaction is preapproved (step 1935). If the transaction is preapproved, the ATA authorizes the transaction (step 1980). If the transaction is not preapproved, the ATA declines the transaction (step 1940). A CIB may then decline the transaction (step 1945).

The ATA then queries the account holders via mobile devices (step 1950) for authorization. The ATA notifies the purchaser that the transaction was declined and that authorization of the subsequent transaction is pending (step 1955). The account holders authorize or decline the subsequent transaction with congruent parameters (step 1960). If sufficient account holders have given authorization (step 1965), the purchaser and account holders are notified of the authorization (step 1975). If the proper authorization is not obtained, the purchaser and account holders are notified of the authorization failure (step 1970). The ATA system authorizes the transaction (step 1980), and the purchaser provides the merchant with notification that the transaction was approved (step 1985). The transaction is then completed (step 1990).

The systems, methods and features described above with reference to FIGS. 15-19, alone or in various combinations, may provide the customer with additional security against theft and fraud. In one example, a user attempting to obtain unauthorized access to the ATA (170) would be required to take at least the following steps:
Provide a credit card number
Provide a card verification value (CVV) code
Provide a billing address and zip code
Provide a customer mobile number
Send a false SMS text from a device different from the customer's mobile phone
Provide a PIN (changeable by the customer)
Use a unique call-in number (assigned to the customer)
   These many layers of security would make unauthorized use of a customer's account and assets highly unlikely. The systems, methods and features described with reference to FIGS. 15-20 may be combined or used in any manner with those embodiments described herein with reference to FIGS. 1-14.

### V. General System Features

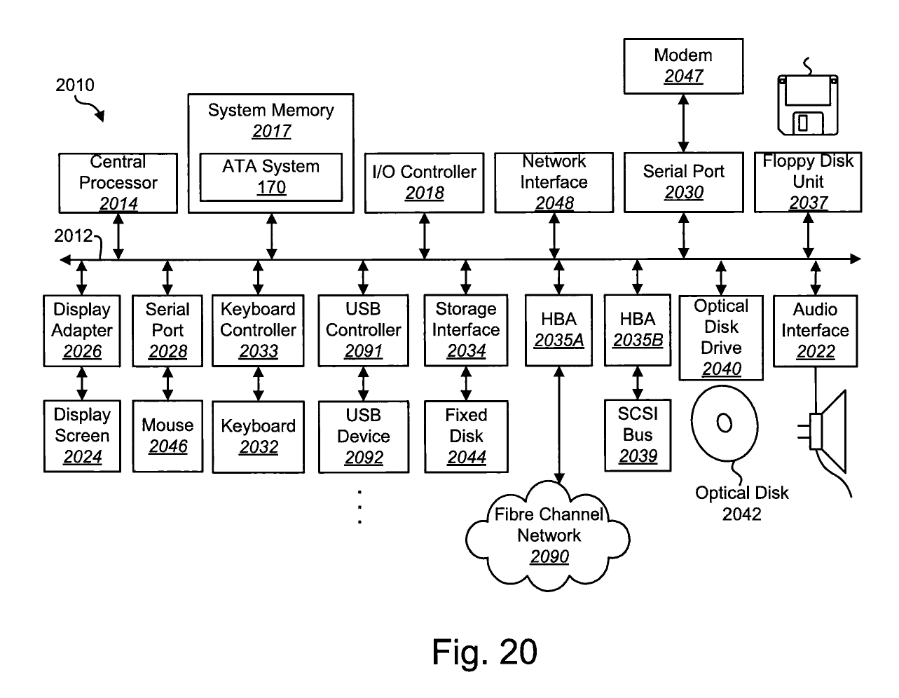

FIG. 20 depicts a block diagram of a computer system 2010 suitable for implementing the present systems and methods. Computer system 2010 includes a bus 2012 which interconnects major subsystems of computer system 2010, such as a central processor 2014, a system memory 2017 (typically RAM, but which may also include ROM, flash RAM, or the like), an input/output controller 2018, an external audio device, such as a speaker system 2020 via an audio output interface 2022, an external device, such as a display screen 2024 via display adapter 2026, serial ports 2028 and 2030, a keyboard 2032 (interfaced with a keyboard controller 2033), multiple USB devices 2092 (interfaced with a USB controller 2090), a storage interface 2034, a floppy disk drive 2037 operative to receive a floppy disk 2038, a host bus adapter (HBA) interface card 2035A operative to connect with a Fibre Channel network 2090, a host bus adapter (HBA) interface card 2035B operative to connect to a SCSI bus 2039, and an optical disk drive 2040 operative to receive an optical disk 2042. Also included are a mouse 2046 (or other point-and-click device, coupled to bus 2012 via serial port 2028), a modem 2047 (coupled to bus 2012 via serial port 2030), and a network interface 2048 (coupled directly to bus 2012).

Bus 2012 allows data communication between central processor 2014 and system memory 2017, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the ATA system 170 to implement the present systems and methods may be stored within the system memory 2017. Applications resident with computer system 2010 are generally stored on and accessed via a computer readable medium, such as a hard disk drive (e.g., fixed disk 2044), an optical drive (e.g., optical drive 2040), a floppy disk unit 2037, or other storage medium. Additionally, applications can be in the form of electronic signals modulated in accordance with the application and data communication technology when accessed via network modem 2047 or interface 2048.

Storage interface 2034, as with the other storage interfaces of computer system 2010, can connect to a standard computer readable medium for storage and/or retrieval of information, such as a fixed disk drive 2044. Fixed disk drive 2044 may be a part of computer system 2010 or may be separate and accessed through other interface systems. Modem 2047 may provide a direct connection to a remote server via a telephone link or to the Internet via an internet service provider (ISP). Network interface 2048 may provide a direct connection to a remote server via a direct network link to the Internet via a POP (point of presence). Network interface 2048 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 20 need not be present to practice the present systems and methods. The devices and subsystems can be interconnected in different ways from that shown in FIG. 20. The operation of a computer system such as that shown in FIG. 20 is readily known in the art and is not discussed in detail in this application. Code to implement the present disclosure can be stored in computer-readable medium such as one or more of system memory 2017, fixed disk 2044, optical disk 2042, or floppy disk 2038. The operating system provided on computer system 2010 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The preceding description has been presented only to illustrate and describe embodiments of the principles described herein. It is not intended to be exhaustive or to limit the disclosure to any precise form disclosed. The principles described herein may be practiced otherwise than is specifically explained and illustrated without departing from their spirit or scope. For example, the principles described herein may be implemented in a wide variety of authorization applications, including, but not limited to, security systems, online payment authorization, remote access protocols, etc. It is intended that the scope of the invention be defined by the following claims.

What is claimed is:

1. A credit theft prevention system, comprising:
a processor;
memory in electronic communication with the processor;
an asynchronous transaction authorization (“ATA”) module disposed on the memory, wherein the ATA module, when accessed by the processor, is configured to:
receive a transaction request at a point of sale device initiated with a purchaser's cellular phone having a near field communication (“NFC”) device;
communicate a purchase amount from the point of sale device to the cellular phone using the NFC device;
receive authorization for the purchase amount from the purchaser via the cellular phone using the NFC device;
transmit a credit card number for the transaction from the cellular phone to the point of sale device using the NFC device;
process the transaction.

2. The system of claim 1, wherein the ATA module, when accessed by the processor, is configured to request separate authorization for the transaction from at least one authorized cardholder associated with the credit card via SMS.

3. The system of claim 1, wherein the ATA module, when accessed by the processor, is configured to request separate authorization for the transaction from at least one authorized cardholder associated with the credit card via MMS.

4. The system of claim 1, wherein the ATA module, when accessed by the processor, is configured to request separate authorization for the transaction from at least one authorized cardholder associated with the credit card via SMTP.

5. The system of claim 1, wherein processing the transaction includes:
recording data related to the transaction;
declining the transaction at the point of sale device;
requesting authorization for the transaction from at least one authorized cardholder associated with the credit card;
storing data associated with the authorization when the requested authorization is received;
prompting the purchaser to re-try the transaction;
receiving data associated with the re-try transaction;
comparing the data associated with the re-try transaction to data associated with the authorization;
approving the transaction when the data associated with the re-try transaction is sufficiently similar to the data associated with the authorization.

6. The system of claim 5, further comprising prompting the purchaser to re-try the transaction when a pre-determined percentage of authorized cardholders associated with the credit card authorize the re-try transaction.

7. The system of claim 1, wherein the ATA is further configured to, when accessed by the processor, require the purchaser to use at least one of a keyword and a unique identification number to authorize the purchase amount.

8. The system of claim 1, wherein the ATA is further configured to obtain pre-authorization from a card issuing bank by transmitting a pre-authorization request to the card-issuing bank, receiving pre-approval of an imminent transaction from the card issuing bank, and notifying at least one of the purchaser and the point of sale device of the pre-authorization by the card issuing bank.

9. A credit theft prevention system, comprising:
a processor;
memory in electronic communication with the processor;
an asynchronous transaction authorization (“ATA”) module disposed on the memory, wherein the ATA module, when accessed by the processor, is configured to:
receive a transaction request at a point of sale device having a first near field communication (“NFC”) device initiated with a purchaser's cellular phone having a second NFC device;
communicate a purchase amount from the point of sale device to the cellular phone via the Internet;
receive authorization for the transaction at the purchase amount from the purchaser to the point of sale device via the Internet;
obtain a credit card number associated with the second NFC device via the Internet;
process the transaction.

10. The system of claim 9, wherein the purchaser provides authorization for the transaction and a credit card number to the point of said device via the Internet.

11. The system of claim 10, wherein processing the transaction occurs automatically if pre-approval for the purchase amount is on file.

12. The system of claim 11, wherein processing the transaction includes:
declining the authorized transaction at the point of sale device;
requesting authorization for the authorized transaction from at least one authorized cardholder associated with the credit card;
prompting the purchaser to re-try the authorized transaction;
approving the re-tried authorized transaction when the data associated with the re-try transaction is sufficiently similar to the data associated with the authorization.

13. The system of claim 12, further comprising prompting the purchaser to re-try the transaction when a pre-determined percentage of authorized cardholders associated with the credit card authorize the re-try transaction.

14. The system of claim 12, further comprising initiating a session when prompting a purchaser to re-try the transaction, wherein the session authorizes the transaction for a predefined time period.

15. The system of claim 12, wherein the receiving a transaction pre-authorization request for a transaction exceeding the pre-defined transaction threshold value comprises receiving a pre-authorization request for an expected transaction range.

16. The system of claim 12, wherein the ATA is further configured to, when accessed by the processor, grant pre-authorization only when the at least one authorized cardholder is identified either by keyword or a unique identification number.

17. The system of claim 9, wherein communicating a purchase amount from the point of sale device to the cellular phone, receiving authorization for the transaction at the purchase amount from the purchaser to the point of sale device, and obtaining a credit card number associated with the second NFC device occur directly between the first and second NFC devices that are in close proximity, or between the first and second NFC devices through the Internet.

18. A credit theft prevention system, comprising:
a processor;
memory in electronic communication with the processor;
an asynchronous transaction authorization (“ATA”) module disposed on the memory, wherein the ATA module, when accessed by the processor, is configured to:
receive a transaction request at a point of sale device initiated with either a purchaser's cellular phone having a near field communication (“NFC”) device or the point of sale device;
communicate a purchase amount from the point of sale device to the cellular phone using the NFC device;
receive authorization for the transaction at the purchase amount from the purchaser via the cellular phone using the NFC device;
obtain a credit card number associated with the NFC device from the Internet after receiving authorization for the transaction;
process the transaction.

19. The system of claim 18, wherein receiving authorization for the transaction further includes requesting authorization for the transaction from at least one authorized cardholder associated with the credit card via at least one of SMS, MMS and SMTP.

20. The system of claim 18, wherein the ATA module is further configured to obtain pre-authorization of an imminent transaction by transmitting a pre-authorization request to a card issuing bank, receiving pre-approval of the imminent transaction from the card issuing bank, and notifying the purchaser and an account holder of the pre-authorization by the card issuing bank.

21. A credit theft prevention system, comprising:
a processor;
memory in electronic communication with the processor;
an asynchronous transaction authorization (“ATA”) module disposed on the memory, wherein the ATA module, when accessed by the processor, is configured to:
receive a transaction request initiated with a purchaser's cellular phone, the transaction request including a purchase amount and being sent to a telephone number unique to the purchaser;
determine whether the purchase amount exceeds a threshold purchase amount;
if the purchase amount exceeds the threshold amount, obtain authorization for the transaction from at least one account holder;
provide authorization for the transaction to the purchaser.

22. The system of claim 21, wherein obtaining authorization for the transaction is conducted via one of SMS, MMS and SMTP.

23. The system of claim 21, wherein receiving the transaction request is conducted via one of SMS, MMS and SMTP.

24. The system of claim 21, wherein providing authorization for the transaction to the purchaser is conducted via one of SMS, MMS and SMTP.

25. The system of claim 21, wherein the transaction request includes a PIN unique to the purchaser.

26. The system of claim 25, wherein the PIN and purchase amount are included in a single communication to the ATA module.
